(19) United States
(12) Patent Application Publication
(10) Pub. No.: US 2026/0239137 A1
(43) Pub. Date: Aug. 13, 2026

(54) MANAGING SELECTIVE ACTIVATION FOR CONDITIONAL PSCELL ADDITION OR CHANGE IN A DISAGGREGATED BASE STATION

(71) Applicant: Google LLC, Mountain View, CA (US)

(72) Inventors: Ching-Jung Hsieh, Taoyuan City (TW); Chih-Hsiang Wu, Taoyuan City (TW)

(21) Appl. No.: 19/157,276

(22) PCT Filed: Feb. 15, 2024
(86) PCT No.: PCT/US24/15989

§ 371 Date: Aug. 15, 2025

Related U.S. Application Data
(60) Provisional application No. 63/446,334, filed on Feb. 16, 2023.

(51) Int. Cl. H04W 36/08

(52) U.S. Cl. CPC H04W 36/08

(57) ABSTRACT

A centralized unit (CU) of a distributed secondary node (SN) providing dual connectivity to a user equipment (UE) with a master node (MN) in accordance with an initial configuration can implement a method for managing conditional primary-secondary cell (PSCell) addition or change (CPAC) operations. The method includes: initiating, at the CU, an activation preparation procedure for CP AC for the UE; receiving, at the CU from a distributed unit (DU) of the distributed SN and responsive to the initiating, a reference candidate DU (C-DU) configuration for CPAC; and transmitting, from the CU, a conditional SN (C-SN) configuration based on the reference C-DU configuration for the UE.

### CROSS-REFERENCE TO RELATED APPLICATIONS

This application claims priority to and the benefit of the filing date of provisional U.S. Patent Application No. 63/446,334 entitled “MANAGING SELECTIVE ACTIVATION FOR CONDITIONAL PSCELL ADDITION OR CHANGE IN A DISAGGREGATED BASE STATION,” filed on Feb. 16, 2023. The entire contents of the provisional applications are hereby expressly incorporated herein by reference.

### FIELD OF THE DISCLOSURE

This disclosure relates generally to wireless communications and, more particularly, to managing conditional configurations to enable continuous conditional cell changes.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, a user equipment (UE) sometimes concurrently utilizes resources of multiple radio access network (RAN) nodes, such as base stations or components of a distributed base station, interconnected by a backhaul. When the network nodes support different radio access technologies (RATs), the connectivity is referred to as Multi-Radio Dual Connectivity (MR-DC). When a UE operates in MR-DC, one base station operates as a master node (MN) that covers a primary cell (PCell), and the other base station operates as a secondary node (SN) that covers a primary secondary cell (PSCell). The UE communicates with the MN via the PCell and the SN via the PSCell. In other scenarios, the UE transfers a wireless connection from one base station to another base station. For example, a serving base station determines to hand the UE over to a target base station and initiate a handover procedure.

Some procedures exist for a UE to add or change an SN in DC scenarios (e.g., as defined in 3GPP technical specification (TS) 37.340). The procedures involve messaging (e.g., RRC signaling and preparation) between radio access network (RAN) nodes. Such messaging generally causes latency, which in turn increases the probability that the SN addition or SN change procedure will fail. Such legacy procedures, which do not involve conditions that are checked at the UE, can be referred to as “immediate” SN addition and SN change procedures.

Additionally, for both SN or PSCell addition/change, “conditional” procedures have been developed (i.e., conditional SN or PSCell addition/change). Unlike the immediate procedures discussed above, the conditional procedures do not add or change the SN or PSCell, or perform the handover, until the UE determines that a condition is satisfied. As used herein, the term “condition” may refer to a single, detectable state or event (e.g., a particular signal quality metric exceeding a threshold), or to a logical combination of such states or events (e.g., “Condition A and Condition B”, “(Condition A or Condition B) and Condition C”, etc.).

To configure a conditional procedure, the RAN provides the condition to the UE, along with a configuration (e.g., one or more random-access preambles, etc.) that will enable the UE to communicate with the appropriate base station or via the appropriate cell when the condition is satisfied. For a conditional addition of a base station as an SN or a candidate cell as a PSCell, for example, the RAN provides the UE with (i) a condition to be satisfied before the UE is to add the base station as the SN or the candidate cell as the PSCell, and (ii) a configuration that enables the UE to communicate with the base station or PSCell after the condition is satisfied.

In the immediate PSCell addition or change procedure, the RAN (i.e., MN or SN) transmits an RRC reconfiguration message, including multiple configuration parameters, to the UE, and the UE attempts to connect to a target PSCell configured by the RRC reconfiguration message. After the UE successfully connects to the SN via the PSCell, the UE communicates with the SN on the PSCell by using the multiple configuration parameters and security key(s) associated with the PSCell and derived from one or more security configuration parameters in the RRC reconfiguration message. The SN also derives security key(s) that match the security key(s) derived from the UE. After the UE successfully connects to the PSCell, the RAN (e.g., the SN) communicates data with the UE by using the matching security key(s) and the multiple configuration parameters.

In some cases, a candidate SN (C-SN) (or target SN (T-SN), which can be inter-changed with each other throughout this document) provides multiple candidate configurations when, for example, multiple candidate PSCells are available. According to conventional techniques, when the MN completes the preparation for a conditional SN procedure (e.g., conditional SN addition or conditional SN cell change), the MN cannot determine which candidate secondary cell the UE will connect to in the future. Moreover, because the UE connects to the secondary cell only subject to the fulfillment of one or more conditions, the MN cannot determine whether the UE will connect to any of the candidate cells in the future.

With Conditional PSCell change (CPC)/Conditional PSCell addition or change (CPAC), the RAN (e.g., the MN or SN) can transmit multiple candidate configurations to the UE. However, when the UE determines that a triggering condition is fulfilled for a specific one of the candidate configurations, the UE executes the specific candidate configuration and performs random access towards a candidate PSCell configured in the specific candidate configuration. The UE releases the configurations after completing random access towards the candidate PSCell. Because the UE releases all of the candidate configurations, the UE does not perform subsequent CPAC without receiving new candidate configuration(s) from the network. However, it is not clear how to enable continuous CPAC (i.e., subsequent CPAC after a CPAC) without new CPAC preparation from the network. “Continuous CPAC” is also referred to as a MR-DC with selective activation of cell groups aiming at reducing signaling overhead between MN and C-SNs and between MN and UE and interrupting time for SCG change. Moreover, it is not clear how the MN and the C-SNs manage to ensure that the RAN and the UE use the same candidate configuration to communicate with each other when the triggering condition is fulfilled during the continuous CPAC operations. It is also not clear how a reference distributed unit (DU) configuration is used to prepare selective activation configuration(s) in the DU and the central unit (CU) of the C-SN if the C-SN is a disaggregated base station.

### SUMMARY

An example embodiment of the techniques of this disclosure is a method implemented in a centralized unit (CU) of a distributed secondary node (SN) providing dual connectivity to a user equipment (UE) with a master node (MN) in accordance with an initial configuration, the method comprising: initiating, at the CU, an activation preparation procedure for conditional primary-secondary cell (PSCell) addition or change (CPAC) for the UE; receiving, at the CU from a distributed unit (DU) of the distributed SN and responsive to the initiating, a reference candidate DU (C-DU) configuration for CPAC; and transmitting, from the CU, a conditional SN (C-SN) configuration based on the reference C-DU configuration for the UE.

Another example embodiment of these techniques is a method implemented in a distributed secondary node (SN) providing dual connectivity to a user equipment (UE) with a master node (MN) in accordance with an initial configuration, the method comprising: receiving, at a first distributed unit (DU) of the distributed SN, an indication to perform an activation preparation procedure for conditional primary-secondary cell (PSCell) addition or change (CPAC) for the UE; transmitting, from the first DU to a centralized unit (CU) of the distributed SN and responsive to the receiving the indication, a reference candidate DU (C-DU) configuration for CPAC; and receiving, at a second DU of the distributed SN from the CU, a conditional SN (C-SN) configuration based on the reference C-DU configuration for the UE.

Another example embodiment of these techniques is an apparatus, operating as a distributed radio access network (RAN) node, comprising processing hardware and configured to implement the methods above.

### BRIEF DESCRIPTION OF THE DRAWINGS

FIG. 1A is a block diagram of an example system in which a base station and/or a user equipment (UE) can implement the techniques of this disclosure for managing conditional procedures related to a master node (MN) or a secondary node (SN);

FIG. 1B is another block diagram of an example system in which a radio access network (RAN) and a user device can implement the techniques of this disclosure for managing conditional procedures related to an MN or an SN;

FIG. 1C is a block diagram of an example base station including a central unit (CU) and a distributed unit (DU) that can operate in the system of FIG. 1A or FIG. 1B;

FIG. 2 is a block diagram of an example protocol stack according to which the UE of FIGS. 1A-1B can communicate with base stations;

FIG. 3A is a messaging diagram of an example scenario where an MN receives and processes one or more SN configurations from a C-SN during a Conditional SN Addition procedure for continuous CPAC;

FIG. 3B is a messaging diagram of an example scenario where an MN receives and processes one or more SN configurations from a C-SN during an MN-initiated Conditional SN Change procedure for continuous CPAC;

FIG. 3C is a messaging diagram of an example scenario where an MN receives and processes one or more SN configurations from a C-SN during an SN-initiated Conditional SN Change scenario for continuous CPAC;

FIG. 4A is a messaging diagram of an example scenario where the SN initiates an intra-SN continuous CPAC via the MN;

FIG. 4B is a messaging diagram of an example scenario where the SN initiates an intra-SN continuous CPAC without MN involvement;

FIGS. 5A-5C are flow diagrams of example methods where a (C-)SN CU performs continuous CPAC preparation with a DU of the (C-)SN and transmits the conditional configuration to the UE;

FIGS. 6A and 6B are flow diagrams of example methods where a DU of a (C-)SN performs a continuous CPAC preparation with a CU of the (C-)SN;

FIG. 7 is a flow diagram of example methods where an SN CU performs a continuous CPAC with a DU of the SN depending on inter-DU and intra-DU scenario;

FIGS. 8A and 8B are flow diagrams of example methods where an SN CU performs a legacy conditional SN procedure or a continuous CPAC preparation depending on UE capabilities;

FIGS. 9A-9D are flow diagrams of example methods where a C-SN CU performs a continuous CPAC preparation with a DU using a reference C-DU configuration;

FIG. 10 is a flow diagram of example methods where a DU performs a continuous CPAC preparation with a CU based on a received reference C-DU configuration;

FIGS. 11A and 11B are flow diagrams of example methods where a DU performs a continuous CPAC preparation with a CU based on a received or a locally generated reference C-DU configuration;

FIG. 12 is a flow diagram of example methods where a CU performs a continuous CPAC preparation with a DU using one or more reference C-DU configurations; and

FIG. 13 is a flow diagram of example methods where a DU performs a continuous CPAC preparation with a CU based on one or more reference C-DU configurations.

### DETAILED DESCRIPTION OF THE DRAWINGS

As discussed in detail below, a UE and/or one or more base stations manage conditional procedures, such as conditional PSCell addition or change (CPAC). This disclosure may also refer to a conditional PSCell addition procedure and a conditional PSCell change procedure separately using the acronyms CPA and CPC, respectively.

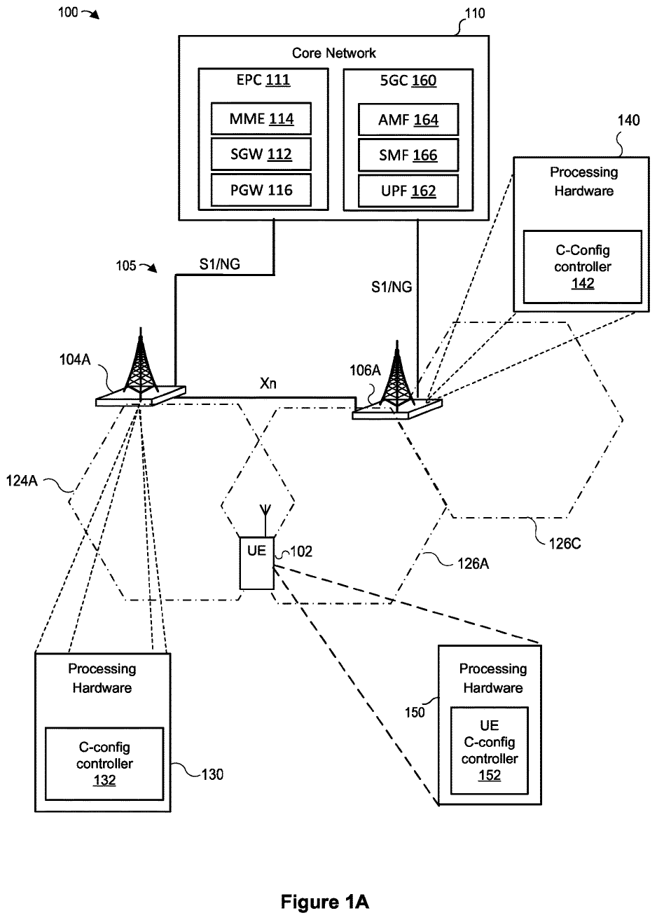

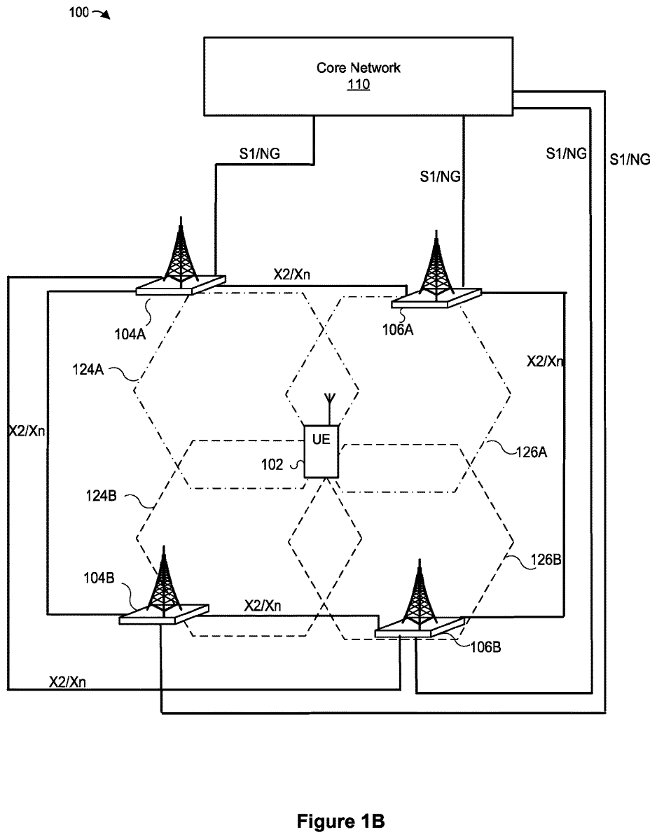

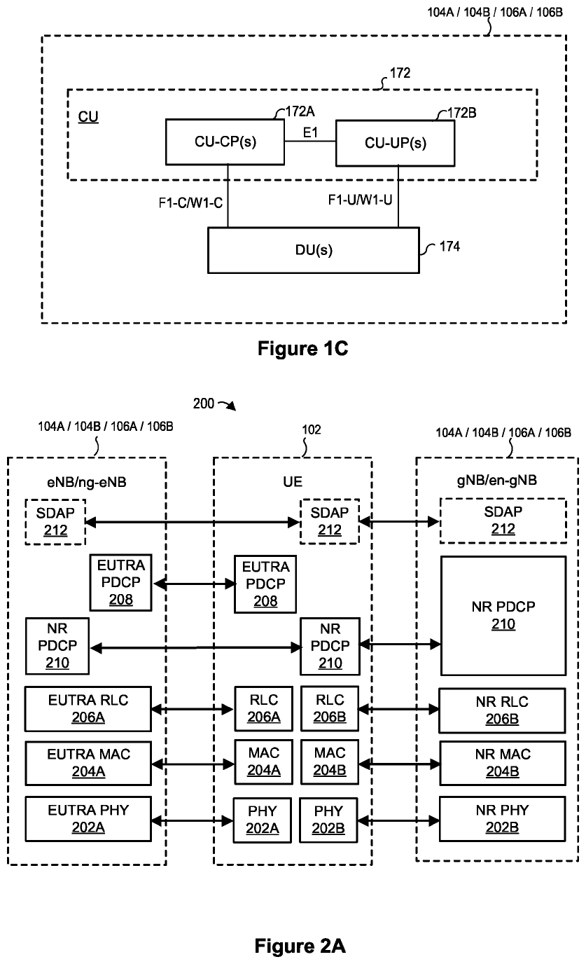

Referring first to FIG. 1A, an example wireless communication system 100 includes a UE 102, a base station (BS) 104A, a base station 106A, and a core network (CN) 110. The base stations 104A and 106A can operate in a RAN 105 connected to the same core network (CN) 110. The CN 110 can be implemented as an evolved packet core (EPC) 111 or a fifth generation (5G) core (5GC) 160, for example.

Among other components, the EPC 111 can include a Serving Gateway (SGW) 112, a Mobility Management Entity (MME) 114, and a Packet Data Network Gateway (PGW) 116.

The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally speaking, the UPF 162 is configured to transfer user-plane packets related to audio calls, video calls, Internet traffic, etc.; the AMF 164 is configured to manage authentication, registration, paging, and other related functions; and the SMF 166 is configured to manage PDU sessions.

As illustrated in FIG. 1A, the base station 104A supports a cell 124A, and the base station 106A supports a cell 126A. Further, each of the base stations 104A, 106A may support more than one cell. The base station 106A, for example, may also support a cell 126C. The cells 124A and 126A can partially overlap, so that the UE 102 can communicate in DC with the base station 104A and the base station 106A operating as a master node (MN) and a secondary node (SN), respectively. To directly exchange messages during DC scenarios and other scenarios discussed below, the MN 104A and the SN 106A can support an X2 or Xn interface. In general, the CN 110 can connect to any suitable number of base stations supporting NR cells and/or EUTRA cells. An example configuration in which the EPC 110 is connected to additional base stations is discussed below with reference to FIG. 1B.

The base station 104A is equipped with processing hardware 130 that can include one or more general-purpose processors such as CPUs and non-transitory computer-readable memory storing machine-readable instructions executable on the one or more general-purpose processors, and/or special-purpose processing units. The processing hardware 130 in an example implementation includes a conditional configuration controller 132 configured to manage conditional configuration for one or more conditional procedures such as Conditional Handover (CHO), Conditional PSCell Addition or Change (CPAC), or Conditional SN Additional or Change (CSAC), when the base station 104A operates as an MN.

The base station 106A is equipped with processing hardware 140 that can also include one or more general-purpose processors such as CPUs and non-transitory computer-readable memory storing machine-readable instructions executable on the one or more general-purpose processors, and/or special-purpose processing units. The processing hardware 140 in an example implementation includes a conditional configuration controller 142 configured to manage conditional configurations for one or more conditional procedures such as CHO, CPAC, or CSAC, when the base station 106A operates as an SN.

Still referring to FIG. 1A, the UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes a UE conditional configuration controller 152 configured to manage conditional configuration for one or conditional procedures.

More particularly, the conditional configuration controllers 132, 142, and 152 can implement at least some of the techniques discussed with reference to the messaging and flow diagrams below. Although FIG. 1A illustrates the conditional configuration controllers 132 and 142 as separate components, in at least some of the scenarios the base stations 104A and 106A can have similar implementations and in different scenarios operate as MN or SN nodes. In these implementations, each of the base stations 104A and 106A can implement both the conditional configuration controller 132 and the conditional configuration controller 142 to support MN and SN functionality, respectively.

In operation, the UE 102 can use a radio bearer (e.g., a DRB or an SRB) that at different times terminates at the MN 104A or the SN 106A. The UE 102 can apply one or more security keys when communicating on the radio bearer, in the uplink (from the UE 102 to a BS) and/or downlink (from a base station to the UE 102) direction. The UE in some cases can use different RATs to communicate with the base stations 104A and 106A. Although the examples below may refer specifically to specific RAT types, 5G NR or EUTRA, in general the techniques of this disclosure also can apply to other suitable radio access and/or core network technologies.

FIG. 1B depicts additional base stations 104B and 106B, which may be included in the wireless communication system 100. The UE 102 initially connects to the base station 104A. In some implementations, the base stations 104B and 106B have similar processing hardware as the base station 106A. The UE 102 initially connects to the base station 104A.

In some scenarios, the base station 104A can perform immediate SN addition to configure the UE 102 to operate in dual connectivity (DC) with the base station 104A (via a PCell) and the base station 106A (via a PSCell other than cell 126A). The base stations 104A and 106A operate as an MN and an SN for the UE 102, respectively. The UE 102 in some cases can operate using the MR-DC connectivity mode, c.g., communicate with the base station 104A using 5G NR and communicate with the base station 106A using EUTRA, or communicate with the base station 104A using EUTRA and communicate with the base station 106A using 5G NR. Multi-connectivity coordination can help the two base stations coordinate shared UE capabilities including operational frequencies (e.g., band combinations, frequency ranges), UE measurements and reporting (e.g., intra-frequency measurements, inter-frequency measurements, inter-RAT measurements, measurement gaps), reception timing (e.g., DRX configurations, offset timing), and uplink power control (e.g., power headroom, maximum transmit power).

At some point, the MN 104A can perform an immediate SN change to change the SN of the UE 102 from the base station 106A (source SN, or “S-SN”) to the base station 104B (target SN, or “T-SN”) while the UE 102 is communicating in DC with the MN 104A and the S-SN 106A. In another scenario, the SN 106A can perform an immediate PSCell change to change the PSCell of the UE 102 to the cell 126A. In one implementation, the SN 106A can transmit a configuration changing the PSCell to cell 126A to the UE 102 via a signaling radio bearer (SRB) (e.g., SRB3) for the immediate PSCell change. In another implementation, the SN 106A can transmit a configuration changing the PSCell to the cell 126A to the UE 102 via the MN 104A for the immediate PSCell change. In some implementations, the MN 104A transmits the configuration immediately changing the PSCell to the cell 126A to the UE 102 via SRB1.

Extending multi-connectivity coordination can help the newly-added base station coordinate shared UE capabilities.

In other scenarios, the base station 104A can perform a conditional SN Addition procedure to first configure the base station 106B as a C-SN for the UE 102, i.e., conditional SN addition or change (CSAC). At this time, the UE 102 can be in single connectivity (SC) with the base station 104A or in DC with the base station 104A and the base station 106A. In some implementations, if the UE 102 is in DC with the base station 104A and the base station 106A, the MN 104A determines to perform the conditional SN Addition procedure in response to a request received from the base station 106A or in response to one or more measurement results received from the UE 102 (e.g., extracted from a UE measurement report) or obtained by the MN 104A from measurements on signals (e.g., sounding reference signal (SRS) or uplink demodulation reference signal (DMRS)) received from the UE 102. In contrast to the immediate SN Addition case discussed above, the UE 102 does not immediately attempt to connect to the C-SN 106B. In this scenario, the base station 104A again operates as an MN, but the base station 106B initially operates as a C-SN rather than an SN.

More particularly, when the UE 102 receives a configuration for the C-SN 106B, the UE 102 does not connect to the C-SN 106B until the UE 102 has determined that a certain condition is satisfied (the UE 102 in some cases can consider multiple conditions, but for convenience only the discussion below refers to a single condition). Before the condition is satisfied, multi-connectivity coordination is not necessary; however, it will be helpful as soon as a C-SN becomes connected. When the UE 102 determines that the condition has been satisfied, the UE 102 connects to the C-SN 106B, so that the C-SN 106B begins to operate as the SN 106B for the UE 102. Thus, while the base station 106B operates as a C-SN rather than an SN, the base station 106B is not yet connected to the UE 102, and accordingly is not yet servicing the UE 102. In some implementations, the UE 102 disconnects from the SN 106A to connect to the C-SN 106B.

In yet other scenarios, the UE 102 is in DC with the MN 104A (via a PCell) and SN 106A (via a PSCell other than cell 126A and not shown in FIG. 1A). The SN 106A can perform conditional PSCell addition or change (CPAC) to configure a candidate PSCell (C-PSCell) 126A for the UE 102. In some implementations, if the UE 102 is configured with a signaling radio bearer (SRB) (e.g., SRB3) to exchange RRC messages with the SN 106A, the SN 106A transmits a configuration for the C-PSCell 126A to the UE 102 via the SRB, e.g., in response to one or more measurement results, which, in some implementations, are received from the UE 102 via the SRB or via the MN 104A, or, in some implementations, are obtained by the SN 106A from measurements on signals received from the UE 102. In case of via the MN 104A, the MN 104A receives the configuration for the C-PSCell 126A. In contrast to the immediate PSCell change case discussed above, the UE 102 does not immediately disconnect from the PSCell and attempt to connect to the C-PSCell 126A.

More particularly, when the UE 102 receives a configuration for the C-PSCell 126A, the UE 102 does not connect to the C-PSCell 126A until the UE 102 has determined that a certain condition is satisfied (the UE 102 in some cases can consider multiple conditions, but for convenience only the discussion below refers to a single condition). When the UE 102 determines that the condition has been satisfied, the UE 102 connects to the C-PSCell 126A, so that the C-PSCell 126A begins to operate as the PSCell 126A for the UE 102. Thus, while the cell 126A operates as a C-PSCell rather than a PSCell, the SN 106A in some implementations does not yet connect to the UE 102 via the cell 126A. In some implementations, the UE 102 disconnects from the PSCell to connect to the C-PSCell 126A.

In some scenarios, the condition associated with CSAC or CPAC can be signal strength/quality, which the UE 102 detects on the C-PSCell 126A of the SN 106A or on a C-PSCell 126B of C-SN 106B, exceeding a certain threshold or otherwise corresponding to an acceptable measurement. For example, when the one or more measurement results the UE 102 obtains on the C-PSCell 126A are above a threshold configured by the MN 104A or the SN 106A or above a pre-determined or pre-configured threshold, the UE 102 determines that the condition is satisfied. When the UE 102 determines that the signal strength/quality on the C-PSCell 126A of the SN 106A is sufficiently good (again, measured relative to one or more quantitative thresholds or other quantitative metrics), the UE 102 can perform a random access procedure on the C-PSCell 126A with the SN 106A to connect to the SN 106A. After the UE 102 successfully completes the random access procedure on the C-PSCell 126A, the C-PSCell 126A becomes a PSCell 126A for the UE 102. The SN 106A then can start communicating data (user-plane data or control-plane data) with the UE 102 through the PSCell 126A. In another example, when the one or more measurement results the UE 102 obtains on the C-PSCell 126B are above a threshold configured by the MN 104A or the C-SN 106B or above a pre-determined or pre-configured threshold, the UE 102 determines that the condition is satisfied. When the UE 102 determines that the signal strength/quality on the C-PSCell 126B of the C-SN 106B is sufficiently good (again, measured relative to one or more quantitative thresholds or other quantitative metrics), the UE 102 can perform a random access procedure on the C-PSCell 126B with the C-SN 106B to connect to the C-SN 106B. After the UE 102 successfully completes the random access procedure on the C-PSCell 126B, the C-PSCell 126B becomes a PSCell 126B for the UE 102 and the C-SN 106B becomes an SN 106B. The SN 106B then can start communicating data (user-plane data or control-plane data) with the UE 102 through the PSCell 126B.

In various configurations of the wireless communication system 100, the base station 104A can be implemented as a master eNB (MeNB) or a master gNB (MgNB), and the base station 106A or 106B can be implemented as a secondary gNB (SgNB) or a candidate SgNB (C-SgNB). The UE 102 can communicate with the base station 104A and the base station 106A or 106B (106A/B) via the same RAT such as EUTRA or NR, or different RATs. When the base station 104A is an MeNB and the base station 106A is an SgNB, the UE 102 can be in EUTRA-NR DC (EN-DC) with the MeNB and the SgNB. In some such scenarios, the MeNB 104A does or does not configure the base station 106B as a C-SgNB to the UE 102. In this scenario, the SgNB 106A may configure cell 126A as a C-PSCell to the UE 102. When the base station 104A is an MeNB and the base station 106A is a C-SgNB for the UE 102, the UE 102 can be in SC with the MeNB. In some such scenarios, the MeNB 104A does or does not configure the base station 106B as another C-SgNB to the UE 102.

In some cases, an MeNB, an SeNB or a C-SgNB is implemented as an ng-eNB rather than an eNB. When the base station 104A is a Master ng-eNB (Mng-eNB) and the base station 106A is a SgNB, the UE 102 can be in next generation (NG) EUTRA-NR DC (NGEN-DC) with the Mng-eNB and the SgNB. In some such scenarios, the MeNB 104A does or does not configure the base station 106B as a C-SgNB to the UE 102. In this scenario, the SgNB 106A may configure cell 126A as a C-PSCell to the UE 102. When the base station 104A is an Mng-NB and the base station 106A is a C-SgNB for the UE 102, the UE 102 can be in SC with the Mng-NB. In some such scenarios, the Mng-eNB 104A does or does not configure the base station 106B as another C-SgNB to the UE 102.

When the base station 104A is an MgNB and the base station 106A/B is an SgNB, the UE 102 may be in NR-NR DC (NR-DC) with the MgNB and the SgNB. In some such scenarios, the MeNB 104A does or does not configure the base station 106B as a C-SgNB to the UE 102.

In this scenario, the SgNB 106A may configure cell 126A as a C-PSCell to the UE 102. When the base station 104A is an MgNB and the base station 106A is a C-SgNB for the UE 102, the UE 102 may be in SC with the MgNB. In some such scenarios, the MgNB 104A does or does not configure the base station 106B as another C-SgNB to the UE 102.

When the base station 104A is an MgNB and the base station 106A/B is a Secondary ng-eNB (Sng-eNB), the UE 102 may be in NR-EUTRA DC (NE-DC) with the MgNB and the Sng-eNB. In some such scenarios, the MgNB 104A does or does not configure the base station 106B as a C-Sng-cNB to the UE 102. In this scenario, the Sng-cNB 106A may configure cell 126A as a C-PSCell to the UE 102. When the base station 104A is an MgNB and the base station 106A is a candidate Sng-eNB (C-Sng-eNB) for the UE 102, the UE 102 may be in SC with the MgNB. In some such scenarios, the MgNB 104A does or does not configure the base station 106B as another C-Sng-eNB to the UE 102.

The base stations 104A, 106A, and 106B can connect to the same core network (CN) 110, which can be an evolved packet core (EPC) 111 or a fifth-generation core (5GC) 160. The base station 104A can be implemented as an eNB supporting an S1 interface for communicating with the EPC 111, an ng-eNB supporting an NG interface for communicating with the 5GC 160, or as a base station that supports the NR radio interface as well as an NG interface for communicating with the 5GC 160. The base station 106A can be implemented as an EN-DC gNB (en-gNB) with an S1 interface to the EPC 111, an en-gNB that does not connect to the EPC 111, a gNB that supports the NR radio interface as well as an NG interface to the 5GC 160, or a ng-eNB that supports an EUTRA radio interface as well as an NG interface to the 5GC 160. To directly exchange messages during the scenarios discussed below, the base stations 104A, 106A, and 106B can support an X2 or Xn interface.

As illustrated in FIG. 1B, the base station 104A supports a cell 124A, the base station 104B supports a cell 124B, the base station 106A supports a cell 126A, and the base station 106B supports a cell 126B. The cells 124A and 126A can partially overlap, as can the cells 124A and 124B, so that the UE 102 can communicate in DC with the base station 104A (operating as an MN) and the base station 106A (operating as an SN) and, upon completing an SN change, with the base station 104A (operating as MN) and the SN 104B. More particularly, when the UE 102 operates in DC with the base station 104A and the base station 106A, the base station 104A operates as an MeNB, an Mng-eNB, or an MgNB, and the base station 106A operates as an SgNB or an Sng-eNB. The cells 124A and 126B can partially overlap. When the UE 102 is in SC with the base station 104A, the base station 104A operates as an MeNB, an Mng-eNB or an MgNB, and the base station 106B operates as a C-SgNB or a C-Sng-eNB.

When the UE 102 operates in DC with the base station 104A and the base station 106A, the base station 104A operates as an MeNB, an Mng-eNB or an MgNB, the base station 106A operates as an SgNB or an Sng-eNB, and the base station 106B operates as a C-SgNB or a C-Sng-eNB.

In general, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure also can apply to other suitable radio access and/or core network technologies such as sixth generation (6G) radio access and/or 6G core network or 5G NR-6G DC.

FIG. 1C depicts an example distributed implementation of a base station such as the base station 104A, 104B, 106A, or 106B. The base station in this implementation can include a central unit (CU) 172 and one or more distributed units (DUs) 174. The CU 172 is equipped with processing hardware that can include one or more general-purpose processors such as CPUs and non-transitory computer-readable memory storing machine-readable instructions executable on the one or more general-purpose processors, and/or special-purpose processing units. In one example, the CU 172 is equipped with the processing hardware 130. In another example, the CU 172 is equipped with the processing hardware 140. The processing hardware 140 in an example implementation includes an (C-)SN RRC controller configured to manage or control one or more RRC configurations and/or RRC procedures when the base station 106A operates as an SN or a candidate SN (C-SN). The base station 106B can have hardware same as or similar to the base station 106A. The DU 174 is also equipped with processing hardware that can include one or more general-purpose processors such as CPUs and non-transitory computer-readable memory storing machine-readable instructions executable on the one or more general-purpose processors, and/or special-purpose processing units. In some examples, the processing hardware in an example implementation includes a medium access control (MAC) controller configured to manage or control one or more MAC operations or procedures (e.g., a random access procedure) and a radio link control (RLC) controller configured to manage or control one or more RLC operations or procedures when the base station 106A operates as an MN, an SN or a candidate SN (C-SN). The processing hardware may include further a physical layer controller configured to manage or control one or more physical layer operations or procedures.

FIG. 2 illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to a EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2). The UE 102, in some implementations, supports both the EUTRA and the NR stack, as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or an RRC sublayer (not shown in FIG. 2) to exchange RRC messages or non-access-stratum (NAS) messages, for example. On a user plane, the EUTRA PDCP sublayer 208 and the NR PDCP sublayer 210 can provide data radio bearers (DRBs) to support data exchange. Data exchanged on the NR PDCP sublayer 210 can be SDAP PDUs, Internet Protocol (IP) packets, or Ethernet packets.

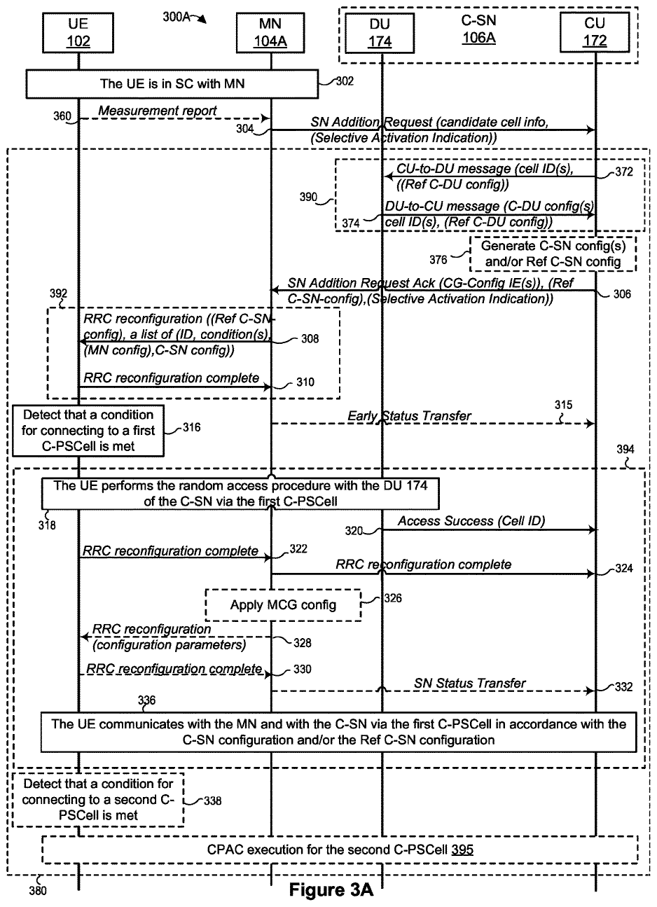

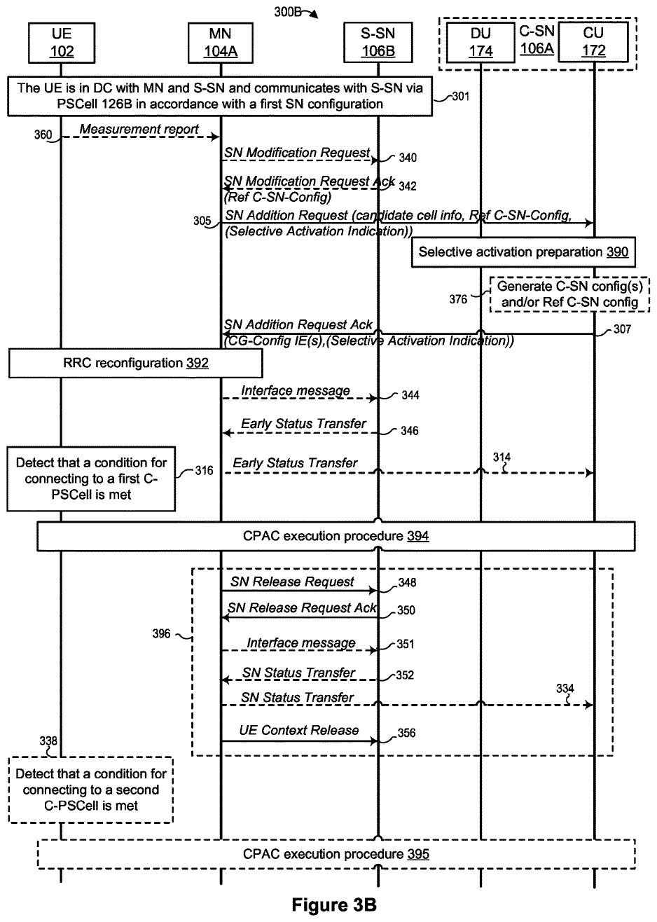

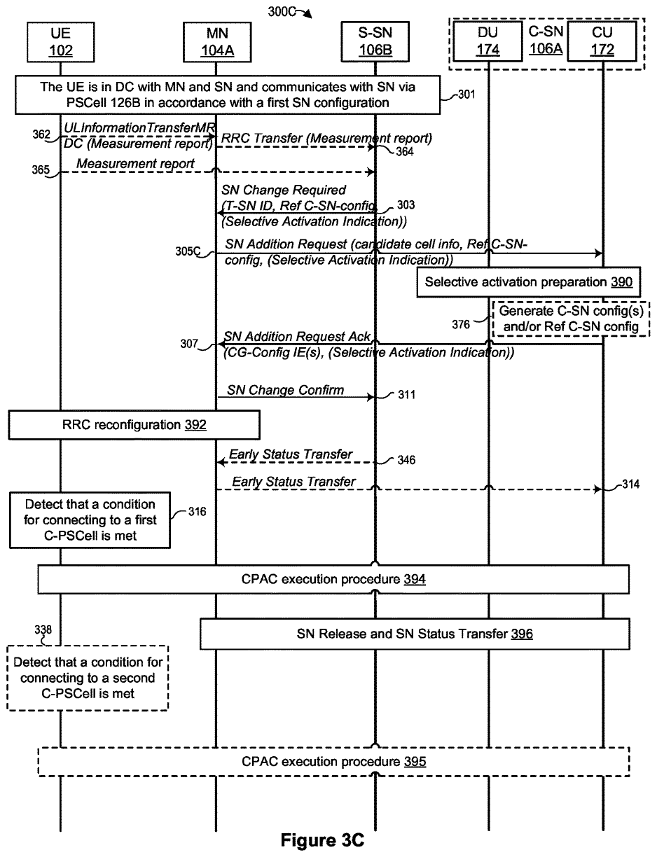

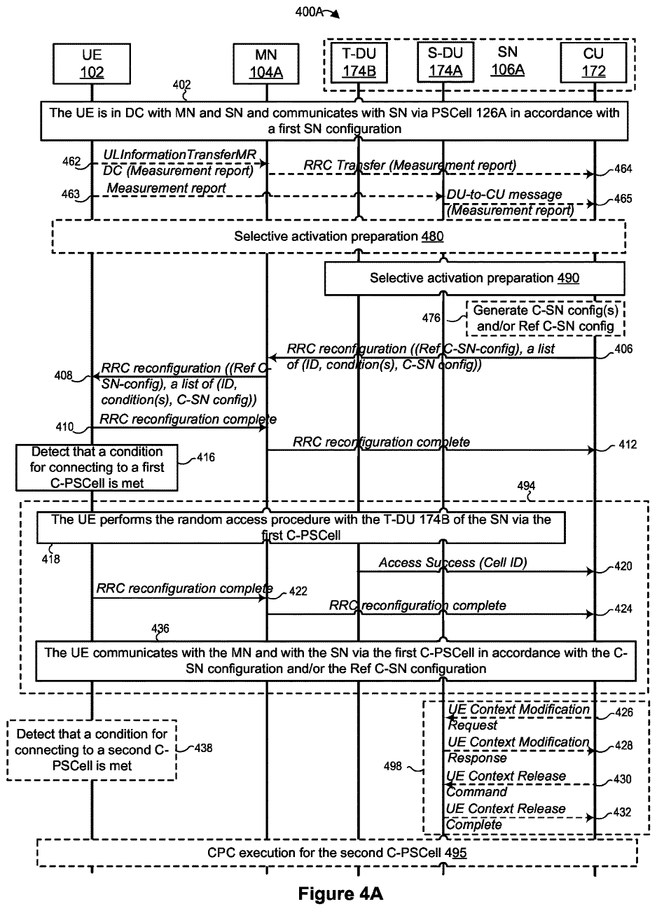

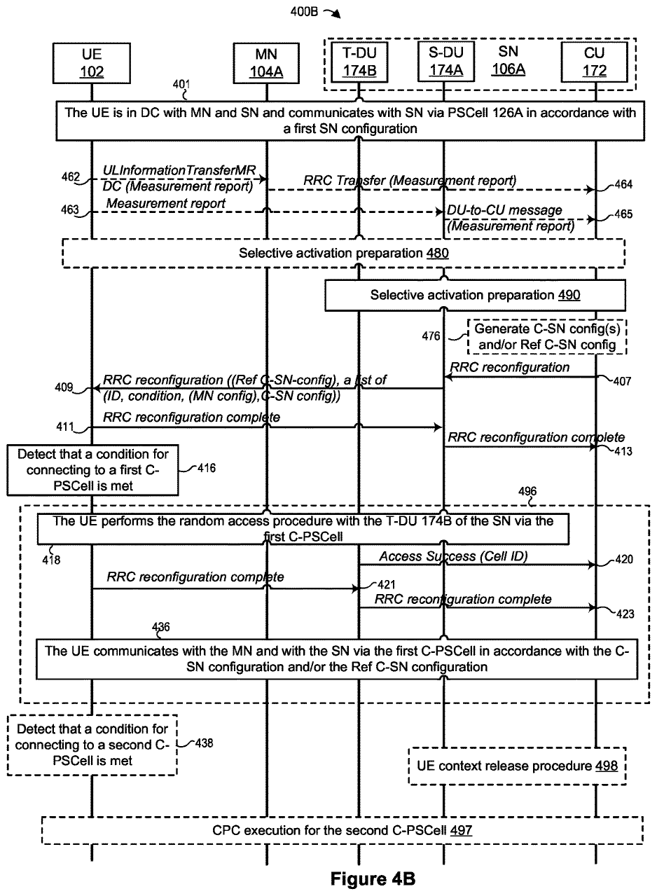

Next, several example scenarios in which a UE and/or a RAN perform the techniques of this disclosure for supporting conditional procedures are discussed with reference to FIGS. 3A-3C and 4A-B. Generally speaking, similar events in FIGS. 3A-3C and 4A-B are labeled with the same reference numbers, with differences discussed below where appropriate.

Referring first to FIG. 3A, in a scenario 300A, an MN receives and processes one or more C-SN configurations from a C-SN during a conditional SN addition procedure. In the scenario 300A, the base station 104A operates as an MN, and the base station 106A operates as a C-SN. The base station 106A includes a CU 172 and a DU 174, and the DU 174 operates the cell 126A and other cells. Initially, the UE 102 operates 302 in single connectivity (SC) with the MN 104A. While in SC, the UE 102 communicates UL PDUs and/or DL PDUs with the MN 104A (e.g., via a PCell 124A) in accordance with an MN configuration.

Later in time, the MN 104A determines to configure the base station 106A as a C-SN for conditional PSCell addition (CPA) for the UE 102. In some implementations, the MN 104A makes the determination based on measurement result(s) from the UE 102, for example. In some implementations, the UE 102 performs measurements and transmits the measurement result(s) in accordance with a measurement configuration configured by the MN 104A. In some implementations, the MN 104A detects or estimates that the UE 102 is moving toward coverage (i.e., one or more cells) of the base station 106A based on uplink signals received from the UE 102 or positioning measurement result(s) received from the UE 102. In response to the determination, the MN 104A sends 304 an SN Addition Request message, including a first indication (e.g., Selective Activation Indication IE) for continuous CPAC, to the CU 172 of the C-SN 106A. In the description of this disclosure, “continuous CPAC” is also referred to as an MR-DC with selective activation of cell groups or a “selective activation preparation”. A cell group comprises of one MAC entity, a set of logical channels with associated RLC entities, a primary cell (SpCell), and one or more secondary cells (SCells). In some implementations, the MN 104A includes Conditional PSCell Addition (CPA) information (e.g., Conditional PSCell Addition Information Request IE) in the SN Addition Request message. In some implementations, the Conditional PSCell Addition Information Request IE includes a Maximum Number of PSCells To Prepare IE/field. In some implementations, the MN 104A includes the first indication in the Conditional PSCell Addition Information Request IE. In other implementations, the MN 104A includes the first indication and Conditional PSCell Addition Information Request IE as different IEs (e.g., XnAP or X2AP IEs) of the SN Addition Request message.

In some implementations, the MN 104A generates candidate cell information (e.g., CandidateCellInfoListMN), including the measurement result(s) of the one or more cells, and includes the candidate cell information in the SN Addition Request message. In some implementations, the MN 104A determines SN restriction information to restrict (e.g., values of) configuration parameters that the C-SN 106A can configure for the UE 102 and includes the SN restriction information in the SN Addition Request message. In some implementations, the MN 104A includes the candidate cell information and/or the SN restriction information in an inter-node RRC message (i.e., CG-ConfigInfo IE) and includes the inter-node RRC message in the SN Addition Request message. Alternatively, the MN 104A includes the SN restriction information outside of the CG-ConfigInfo in the SN Addition Request message. In some implementations, the MN 104A determines MN restriction information to restrict (e.g., values of) configuration parameters that the MN 104A can configure for the UE 102 when determining the SN restriction information. In some implementations, the MN 104A includes CPA information in the SN Addition Request message. For example, the CPA information (e.g., Conditional PSCell Addition Information Request IE) includes an IE indicating the maximum number of PSCells that the C-SN 106A prepares.

In some implementations, the MN 104A includes a first reference C-SN configuration in the SN Addition Request message for the purpose of continuous CPAC. In some implementations, the MN 104A obtains the first reference C-SN configuration (e.g., C-SN configuration 0) from a C-SN (e.g., C-SN 0). Alternatively, the MN 104A is pre-configured with the first reference C-SN configuration. As yet another alternative, the MN 104A generates the first reference C-SN configuration. In other implementations, the MN 104A refrains from including a first reference C-SN configuration in the SN Addition Request message, when the MN 104A decides to perform CPA to the C-SN 106A and there is no available first reference C-SN configuration. In some implementations, the CU 172 of the C-SN 106A decodes the first reference C-SN configuration received from the MN 104A (e.g., in event 304) and extracts or generates the first reference C-DU configuration based on the first reference C-SN configuration. The reference C-DU configuration configures the lower layer parameters, including physical layer configuration parameters, MAC configuration parameters, and/or RLC configuration parameters of a cell group. In some implementations, the reference C-DU configuration is a pre-defined CellGroupConfig IE (e.g., defined in 3GPP TS 38.331). In other implementations, the reference C-DU configuration includes configuration parameters in the CellGroupConfig IE.

The reference C-SN configuration, in addition to the reference C-DU configuration, further consists of a reference CU configuration. In some implementations, the reference CU configuration includes PDCP configuration parameters, measurement configuration parameters, and/or radio bearer configuration parameters. In some implementations, the reference CU configuration includes a pre-defined MeasConfig IE and/or RadioBearerConfig IE (e.g., defined in 3GPP TS 38.331) or includes configuration parameters in the MeasConfig IE and/or RadioBearerConfig IE. In other implementations, the CU 172 of the C-SN 106A does not have the first reference C-SN configuration, and therefore does not generate the first reference C-DU configuration. In some implementations, the CU 172 of the C-SN 106A does not decode and re-encode the reference C-DU configuration from the reference C-SN configuration.

In response to receiving 304 the SN Addition Request message with CPAC indication, the first indication, and/or the reference C-SN configuration, the CU 172 of the C-SN 106A determines M₁ C-PSCell(s) (where M₁ is a positive integer) operated by the DU 174.

In some implementations, the CU 172 sends 372 a first CU-to-DU message, including the cell identity (ID) for the first C-PSCell and/or the first reference C-DU configuration, to the DU 174 for the UE 102. For example, the cell ID is a cell global identity (CGI). In some implementations, the first reference C-DU configuration is contained in the reference C-SN configuration or in the RRC container (e.g., CG-ConfigInfo IE) that the CU 172 received from the MN 104A. In other implementations, the first reference C-DU configuration is solely included in the first CU-to-DU message. The DU 174 in response sends 374 a first DU-to-CU message, including the first C-DU configuration for the first C-PSCell. In some implementations, the DU 174 includes the cell ID for the first C-PSCell and/or a second reference C-DU configuration in the DU-to-CU message. The CU 172 and the DU 174 identify the C-DU configuration by the cell ID for the UE 102.

Events 372 and 374 can be collectively referred to as a selective activation preparation procedure 390. In some implementations, the CU 172 and the DU 174 perform 390 the selective activation preparation procedure(s) sequentially or in parallel with the first C-PSCell for the rest of (M₁−1) C-PSCell(s) in response to the determination. The CU 172 therefore obtains, from the DU 174, the M₁ C-DU configuration(s), where each C-DU configuration is associated with a particular C-PSCell of the MIC-PSCell(s) (i.e., C-PSCell(s) 1, . . . , M₁).

In another implementation, the CU 172 sends 372 a CU-to-DU message, including the cell ID(s) for the M₁ C-PSCell(s) and/or the first reference C-DU configuration, to the DU 174. The DU 174, in response, sends 374 a DU-to-CU message including the M₁ C-DU configuration(s) for the first C-PSCell. In some implementations, the DU 174 includes the cell ID(s) for the M₁ C-PSCell(s) and/or a second reference C-DU configuration in the DU-to-CU message. In such implementation, the CU 172 obtains, from the DU 174, the M₁ C-DU configuration(s) using a single selective activation preparation procedure 390.

In some implementations, the CU-to-DU message at the event 372 is a UE Context Setup Request or a UE Context Modification Request message, and the DU-to-CU message at the event 374 is a UE Context Setup Response or a UE Context Modification Response message. In some implementations, the DU 174 generates the C-DU configuration(s) based on the first reference C-DU configuration if the DU 174 receives the first reference C-DU in the CU-to-DU message. In such cases, the DU 174 generates the C-DU configuration(s) 1 and/or 2, . . . , M₁, which are delta configuration(s) to augment the first reference C-DU configuration. In other implementations, the DU 174 does not receive the first reference C-DU configuration from the CU 172 and generates the second reference C-DU configuration from scratch. The DU 174 in such implementations generates the C-DU configuration(s) based on the second reference C-DU configuration. In such cases, the DU 174 generates the C-DU configuration(s) 1 and/or 2, . . . , M₁, which are delta configuration(s) to augment the second reference C-DU configuration. In some implementations, the CU 172 includes, in the first CU-to-DU message, an indication of selective activation or a query for the reference C-DU configuration, and the DU 174 gencrates the second reference C-DU configuration in response to the indication or query.

The CU 172, based on the received C-DU configuration(s) 1, . . . , M₁, generates 376 the C-SN configuration(s) 1, . . . , M₁ for the UE 102, where each C-SN configuration is associated with a particular C-PSCell of the M₁ C-PSCell(s) (i.e., C-PSCell(s) 1, . . . , M₁), respectively. For example, the C-PSCell(s) includes the cell 126A and/or the cell 126C. In some implementations, the CU 172 also generates 376 a second reference C-SN configuration based on the second reference C-DU configuration. In some implementations, the CU 172 generates the CU configuration, including PDCP configuration parameters, measurement configuration parameters, and/or radio bearer configuration parameters. The CU 172 generates the C-SN configuration(s) by combining the C-DU configuration(s) and the CU configuration(s). In some implementations, the CU 172 generates the second reference C-SN configuration similarly. The CU 172 generates an inter-node message (e.g., CG-CandidateList) to include the C-SN configuration(s) 1, . . . , M₁ for the UE 102. In some implementations, M₁ is not larger than the maximum number of PSCells received in the SN Addition Request message or determined by the C-SN 106A. In some implementations, the CU 172 of the C-SN 106A determines the C-PSCell(s) and the C-SN configuration(s) 1, . . . , M₁, considering the candidate cell information and the SN restriction information. The inter-node message includes an addition list (e.g., eg-19 CandidateToAddModList) of CG-CandidateInfo IE(s), where each corresponds to a C-PSCell. Each CG-CandidateInfo IE in the addition list includes a CG-CandidateInfo ID (e.g., cg-CandidateInfoId or CG-CandidateInfoId that includes C-PSCell information for a C-PSCell (e.g., SSB frequency information (e.g., ARFCN-ValueNR)) and the physical Cell ID (PCI)) and a CG-Config IE. Each CG-Config IE includes a C-SN configuration for a corresponding C-PSCell and, optionally, parameters for the MN 104A to prepare a corresponding MN configuration to coordinate with the C-SN configuration, if necessary. In some implementations, the C-SN 106A and the MN 104A uses the CG-CandidateInfo ID(s) for management of CG-CandidateInfo IE(s) in the addition list. In some implementations, the MN 104A uses the first indication to indicate to the C-SN 106A that (e.g., unlike conventional CPAC procedure), the prepared C-SN configuration(s) will not be released by the UE 102 when UE 102 accesses one of the C-SN configuration(s) from the C-SN 106A or other C-SN(s).

The CU 172 of the C-SN 106A transmits 306 an SN Addition Request Acknowledge message, including the CG-CandidateList, and/or a Conditional PSCell Addition Information Acknowledge IE, including the list of accepted candidate cell (CGI), to the MN 104A in response to the SN Addition Request message. The CU 172 of the C-SN 106A includes the MI C-SN configuration(s) in the CG-CandidateList. In some implementations, the CU 172 of the C-SN 106A includes a reference C-SN configuration (e.g., Ref C-SN-config) in the SN Addition Request Acknowledge message for the MN 104A to prepare CPAC with other C-SN(s) for the UE 102 as described below. In some implementations, the CU 172 of the C-SN 106A includes the reference C-SN configuration and the CG-CandidateList in separate IEs (e.g., XnAP or X2AP IEs) of the SN Addition Request Acknowledge message. In other implementations, the CU 172 of the C-SN 106A includes the reference C-SN configuration in the CG-CandidateList IE.

In some implementations, the MN 104A includes an indication to request a reference C-SN configuration. The CU 172 of the C-SN 106A includes the reference C-SN configuration in the SN Addition Request Acknowledge message in response to the indication. Depending on the implementation, the indication is an IE such as a query IE (e.g., Reference C-SN Configuration Query), a reference configuration request IE, or a reference configuration indication IE. In some implementations, each of the M₁ C-SN configuration(s) is a delta configuration augmenting the reference C-SN configuration. In other words, the M₁ C-SN configuration(s) are associated with the reference C-SN configuration. In other implementations, the CU 172 of the C-SN 106A refrains from including a reference C-SN configuration in the SN Addition Request Acknowledge message. In some implementations, the reference C-SN configuration included in the SN Addition Request Acknowledge message is the second reference C-SN configuration that the CU 172 of the C-SN 106A generates based on the second reference C-DU configuration received from the DU 174, as described above. In other implementations, the reference C-SN configuration included in the SN Addition Request Acknowledge message is the first reference C-SN configuration that the CU 172 of the C-SN 106A receives in the SN Addition Request message.

In some implementations, after receiving 306 the SN Addition Request Acknowledge message, including the CG-CandidateList, the MN 104A assigns a particular configuration ID (e.g., condReconfigId or CondReconfigurationId) to each of the C-SN configuration(s) in the CG-Config IE(s). For example, in cases where the CG-Config IE(s) 1, . . . , M₁ include the C-SN configuration(s) 1, . . . , M₁, the MN 104A assigns configuration ID(s) 1, . . . , M₁ for the C-SN configuration(s) 1, . . . , M₁, respectively. In some implementations, the MN 104A generates the triggering condition configuration(s) (e.g., condExecutionCond field(s)/IE(s)) for the C-SN configuration(s) 1, . . . , M₁, respectively. In some implementations, each of the triggering condition configuration(s) configures one or more conditions that triggers the UE 102 to connect to the C-SN 106A via a particular C-PSCell configured in a particular C-SN configuration. In some implementations, the MN 104A generates corresponding MN configuration(s) 1, . . . , M₁, based on the parameters received in the CG-Config IE(s) 1, . . . , M₁, to coordinate with the C-SN configuration(s) 1, . . . , M₁, respectively. In some implementations, the MN 104A generates MN message(s) or RRC container message(s) (e.g., RRCConnectionReconfiguration messages or RRCReconfiguration messages) 1, . . . , M₁, including the C-SN configuration(s) and/or the corresponding MN configuration(s) 1, . . . , M₁, respectively. The MN 104A generates condRRCReconfig field(s)/IE(s) 1, . . . , M₁ to include the MN message(s) or RRC container message(s) 1, . . . , M₁, respectively. The MN 104A generates conditional (re)configuration field(s)/IE(s) (e.g., CondReconfigToAddMod field(s)/IE(s)) 1, . . . , M₁, including the condRRCReconfig field/IE 1, . . . , M1; the configuration ID(s) (e.g., condReconfigId) 1, . . . , M₁; and the triggering condition configurations (e.g., condExecutionCond) 1, . . . , M₁, respectively.

The MN 104A transmits 308 an RRC reconfiguration message, including the conditional (re)configuration fields/IEs 1, . . . , M₁, to the UE 102. For example, the RRC reconfiguration message is an RRCConnectionReconfiguration message or RRCReconfiguration message. In some implementations, the MN 104A generates a first list (e.g., CondReconfigToAddModList) of the conditional (re)configuration field/IEs (e.g., CondReconfigToAddMod). The MN 104A transmits 308 the RRC reconfiguration message, including the first list, to the UE 102.

In some implementations, the MN 104A includes the reference C-SN configuration in the RRC reconfiguration message in the event 308. In other implementations, the MN 104A includes the reference C-SN configuration in a separate RRC reconfiguration message other than the RRC reconfiguration message of the event 308 and transmits the separate RRC reconfiguration message to the UE 102. In some implementations, the MN 104A includes the reference C-SN configuration in the first list. In other implementations, the MN 104A does not include the reference C-SN configuration in the first list, but in a separate field/IE in the RRC reconfiguration message of the event 308. In response, the UE 102 transmits 310 an RRC reconfiguration complete message (e.g., RRCConnectionReconfigurationComplete message or RRCReconfigurationComplete message) to the MN 104A. The events 308 and 310 collectively define an RRC reconfiguration procedure 392.

In some implementations, based on the determination to perform continuous CPAC, the MN 104A determines to configure an additional N−1 C-SNs for the UE 102, where N is a positive integer larger than 1. In such cases, the C-SN 106A is the first C-SN (i.e., C-SN 1) among the total NC-SNs. The interactions between the MN 104A and the C-SN 2, . . . , N, are similar to the interactions between the MN 104A and the C-SN 1, as described above for the events 304, 306, 372, 374, 376, 308, and 310. In some implementations, if the C-SN 1 (i.e., C-SN 106A) includes a reference C-SN configuration in the SN Addition Request Acknowledge message 306 for the MN 104A, as described above, the MN 104A includes the reference C-SN configuration in SN Addition Request messages that the MN 104A transmits to the C-SN(s) 2, . . . , N, respectively. Each of the C-SN(s) 2, . . . , N, therefore, generates C-SN configuration(s) based on the reference C-SN configuration. In some implementations, each of the C-SN configuration(s) is a delta configuration augmenting the reference C-SN configuration. In cases where the C-SN 2, . . . , N also consist of CU and DU(s), the interactions between the CU and the DU(s) are similar to the interactions between the CU 172 and the DU 174 of the C-SN 106A, as described above in the events 372, 374, and 376.

In some implementations, for each of the N−1 C-SN(s), the MN 104A performs an RRC reconfiguration procedure with the UE 102, similar to the event 392. In other implementations, the MN 104A includes the C-SN configuration(s) received from the N−1 C-SN(s) in the RRC reconfiguration message of the event 308, similar to including the C-SN configuration(s) 1, . . . , M₁, as described above. In some implementations, the MN 104A manages the C-SN configurations from the NC-SNs for the UE 102, as described below. In some implementations, the MN 104A determines that there are M1 C-SN configurations from the C-SN 1, M2 C-SN configurations from the C-SN 2, . . . , and MN C-SN configurations from the C-SN N, where Mᵢ is a positive integer and i is a number between 1 to N. The MN 104A, for example, assigns configuration ID 1, . . . , M₁ to the M₁ C-SN configurations from the C-SN 1 (and the corresponding MN configurations), configuration ID (M)+1), . . . , (M)+M2) to the M2 C-SN configurations from the C-SN2 (and the corresponding MN configurations), . . . , and configuration ID (M₁+M2+ . . . +M_{N-1}+1), . . . , (M)+M2+ . . . +M_{N}) to the M_{N} C-SN configurations from the C-SN N (and the corresponding MN configurations). The MN 104A transmits the (M₁+M2+ . . . +M_{N}) C-SN configurations (and the corresponding MN configurations) in one or more conditional configuration lists (e.g., CondReconfigToAddModList) to the UE 102. For example, the MN 104A transmits the C-SN configurations with configuration ID 1, .. . . , M₁, in a first CondReconfigToAddModList, and transmits the C-SN configurations with configuration ID (M₁+1), . . . , (M1+M2+ . . . +M_{N}) in a second CondReconfigToAddModList to the UE 102.

In some implementations, after receiving 310 the RRC reconfiguration complete message or an acknowledgement (e.g., RLC acknowledgement or hybrid automatic repeat request (HARQ) acknowledgement) for a PDU (e.g., RLC PDU or MAC PDU), including the RRC reconfiguration message 308, the MN 104A determines to send and/or sends 315 an Early Status Transfer message to the C-SN 106A and/or C-SN(s) 2, . . . , N to transfer (i) a COUNT value of the first downlink SDU that the MN 104A forwards to the C-SN 106A and/or C-SN(s) 2, . . . , N or (ii) a COUNT value for discarding of already forwarded downlink SDUs for each of DRB(s) of the UE 102. In some implementations, the Early Status Transfer message is an Early Sequence Number (SN) Status Transfer message, where “SN” in this context refers to sequence number rather than secondary node. In some implementations, the MN 104A sends 315 the Early Status Transfer message without receiving an interface message indicating the UE 102 connects to the C-SN 106A and/or N−1 C-SN(s).

In some implementations, the UE 102 uses the one or more conditions to determine whether to connect to one of the C-PSCell(s). If the UE 102 detects 316 that a condition for connecting to a first C-PSCell (e.g., the C-PSCell 1 of the C-SN 106A) is satisfied, the UE 102 connects to the first C-PSCell. That is, the condition (i.e., “triggering condition”) triggers the UE 102 to connect to the first C-PSCell or to execute the C-SN configuration concerning the first C-PSCell. However, if the UE 102 does not detect that the condition is satisfied, the UE 102 does not connect to the first C-PSCell. In response to the detection, the UE 102 initiates a random access procedure on the first C-PSCell. In response to the initiation, the UE 102 performs 318 the random access procedure with the DU 174 of the C-SN 106A via the first C-PSCell (e.g., the cell 126A). The UE 102 performs the random access procedure in accordance with the random access configurations of the C-DU configuration and/or the reference C-DU configuration. In response to the detection or initiation 316, the UE 102 sends 322 an RRC reconfiguration complete message for the C-SN 106A to the MN 104A. In some implementations, the UE 102 sends 322 the RRC reconfiguration complete message before, during, or after the random access procedure. The DU 174 of the C-SN 106A, after the random access procedure, sends 320 an Access Success message to the CU 172 of the C-SN 106A. The Access Success message includes the Cell ID that the UE 102 accesses successfully.

In some implementations, the UE 102 includes the RRC reconfiguration complete message in an MN RRC message and transmits the MN RRC message at the event 322. The MN RRC message, in some implementations, is an RRCReconfigurationComplete message or an ULInformationTransferMRDC message (e.g., defined in 3GPP TS 38.331). In some implementations, the UE 102 indicates, in the MN RRC message, that the UE 102 has executed one of the C-SN configuration(s) by including a configuration ID corresponding to the particular C-SN configuration. In some implementations, the MN 104A uses the configuration ID to identify or determine the ID of the C-PSCell (e.g., the PCI and/or the CGI of the C-PSCell 126A) and/or the C-SN if the MN 104A performs multiple CPA procedures with different C-SNs. In some implementations, the MN 104A also uses the configuration ID to identify or determine the C-SN configuration or the CG-Config IE, including the C-SN configuration.

In some implementations, in response to or after receiving 322 the RRC reconfiguration complete message, the MN 104A sends 324 the RRC reconfiguration complete message in an SN message to the CU 172 of the C-SN 106A. In some implementations, the SN message is an SgNB Reconfiguration Complete or S-Node Reconfiguration Complete message.

In other implementations, the SN message is an RRC Transfer message. In yet other implementations, the SN message is a specifically designed interface message (e.g., XnAP or X2AP message) (e.g., defined in 3GPP TS 38.423 or 36.423).

In some implementations, the random access procedure is a four-step random access procedure or a two-step random access procedure. In other implementations, the random access procedure is a contention-based random access procedure or a contention-free random access procedure. For example, the UE 102 includes an RRC reconfiguration complete message in a message 3 of the four-step random access procedure or in a message A of the two-step random access procedure.

In response to or after receiving 322 the RRC reconfiguration complete message, the MN 104A applies 326 the corresponding conditional MN configuration. In some implementations, in response to applying 326 the corresponding conditional MN configuration, the MN 104A transmits 328 an RRC reconfiguration message, including configuration parameters, to the UE 102. In some implementations, the configuration parameters 328 reconfigures or releases (e.g., values of) configuration parameters that the UE 102 uses to communicate with the MN 104A. In other implementations, the configuration parameters 328 are new configuration parameters to configure the UE 102 to communicate with the MN 104A. In some implementations, in response to the RRC reconfiguration message 328, the UE 102 transmits 330 an RRC reconfiguration complete message to the MN 104A. In some implementations, the MN 104A in response transmits 332 an SN Status Transfer (e.g., sequence number status transfer) message to transfer uplink PDCP SN and HFN receiver status and/or downlink PDCP SN and HFN transmitter status for each of DRB(s) of the UE 102. In contrast to event 314, the MN 104A sends 334 a (non-early) SN Status Transfer (e.g., sequence number status transfer) message.

After the UE 102 successfully completes 318 the random access procedure, the UE 102 communicates 336 with the MN 104A in accordance with the (updated) MN configuration and with the C-SN 106A via the first C-PSCell in accordance with the C-SN configuration configuring the first C-PSCell and/or the reference C-SN configuration. Specifically, the UE 102 communicates with the DU 174 of the C-SN 106A via the first C-PSCell in accordance with the C-DU configuration configuring the first C-PSCell and/or the reference C-DU configuration. The events 318, 320, 322, 324, 326, 328, 330, and 332 are collectively referred to in FIG. 3A as a CPAC execution procedure 394. In some implementations, the UE 102 later detects 338 that a condition for connecting to a second C-PSCell belonging to the C-SN 106A is met, similar to event 316. In some such implementations, the UE 102, MN 104A, and C-SN 106A therefore perform 395 a CPAC execution procedure for the second C-PSCell, similar to the procedure 394. In some implementations, if the MN 104A configures an additional C-SN (e.g., C-SN 2), the UE 102 later (or before the event 338) detects that a condition for connecting to a C-PSCell belonging to the C-SN 2 is met, similar to the event 316 or 338. In some implementations, the UE 102, MN 104A, and the C-SN therefore perform a CPAC execution procedure for the C-PSCell of the C-SN 2, similar to the event 394 or 395. The events 372, 374, 376, 306, 308, 310, 315, 316, 318, 320, 322, 324, 326, 328, 330, 332, 336, 338, and 395 are collectively referred to in FIG. 3A as a selective activation preparation procedure 380.

With continued reference to FIG. 3A, the C-SN configuration, in some implementations, isa complete and self-contained configuration (i.e., a full configuration). In some implementations, the C-SN configuration includes a full configuration indication (e.g., an information element (IE) or a field) that identifies the C-SN configuration as a full configuration. The UE 102 in some such cases uses the C-SN configuration to communicate with the SN 106A without relying on an SN configuration. In other implementations, the C-SN configuration includes a “delta” configuration, or one or more configurations that augment the reference C-SN configuration. In some such cases, the UE 102 uses the delta C-SN configuration together with the reference C-SN configuration to communicate with the C-SN 106A.

In some implementations, the C-SN configuration includes multiple configuration parameters for the UE 102 to apply when communicating with the SN 106A via a C-PSCell 126A. In some implementations, the multiple configuration parameters configure the C-PSCell 126A and zero, one, or more candidate secondary cells (C-SCells) of the SN 106A to the UE 102. In some implementations, the multiple configuration parameters configure radio resources for the UE 102 to communicate with the C-SN 106A via the C-PSCell 126A and zero, one, or more C-SCells of the C-SN 106A. In some implementations, the multiple configuration parameters configure zero, one, or more radio bearers. In some implementations, the one or more radio bearers include an SRB and/or one or more DRBs.

In some implementations, the C-SN configuration includes a cell group configuration (CellGroupConfig) IE that configures the C-PSCell 126A and zero, one, or more C-SCells of the C-SN 106A. In some implementations, the C-SN configuration includes a radio bearer configuration. In further implementations, the C-SN configuration does not include a radio bearer configuration. For example, the radio bearer configuration is a RadioBearerConfig IE, DRB-ToAddModList IE or SRB-ToAddModList IE, or DRB-ToAddMod IE or SRB-ToAddMod IE. In various implementations, the C-SN configuration is a predefined RRCReconfiguration message, RRCReconfiguration-IEs, or CellGroupConfig IE (e.g., defined in 3GPP TS 38.331).

In some implementations, the full configuration indication is a predefined field or IE (e.g., defined in 3GPP TS 38.331). In some implementations, the reference C-SN configuration includes a cell group configuration (CellGroupConfig) IE that configures the C-PSCell 126A and zero, one, or more C-SCells of the C-SN 106A. In some implementations, the reference C-SN configuration includes a radio bearer configuration. In further implementations, the reference C-SN configuration does not include a radio bearer configuration. In various implementations, the reference C-SN configuration is a predefined RRCReconfiguration message, RRCReconfiguration-IEs, or CellGroupConfig IE (e.g., defined in 3GPP TS 38.331).

Alternatively, the reference C-SN configuration is a specifically defined field or IE including the RRCReconfiguration message, RRCReconfiguration-IEs, or CellGroupConfig IE (e.g., defined in TS 38.331). In some implementations, the full configuration indication is a predefined field or IE (e.g., defined in 3GPP TS 38.331).

FIG. 3B depicts a scenario 300B (i.e., an MN-initiated conditional SN Change for continuous CPC) similar to FIG. 3A. The differences between FIG. 3B and FIG. 3A are described below.

The UE 102 is initially in dual connectivity 301 with MN 104A and S-SN 106B and communicates with S-SN 106B via a PSCell 126B in accordance with a first SN configuration (i.e., current SN configuration, serving SN configuration, or source SN configuration). In some implementations, if the S-SN consists of a CU and a serving DU, the first SN configuration includes a first CU configuration (i.e., a serving CU configuration) that the UE 102 uses to communicate with the CU via the serving DU and a first DU configuration (i.e., a serving DU configuration) that the UE 102 uses to communicate with the serving DU. Later in time, the MN 104A determines to perform a conditional SN change (preparation) procedure with the C-SN 106A for continuous CPC.

In some implementations, unlike the scenario 300A in FIG. 3A where the first reference C-SN configuration is from the C-SN 0, the MN 104A, or the C-SN 1, the MN 104A obtains a first reference C-SN configuration from the S-SN 106B in the scenario 300B. In some implementations, the MN 104A transmits 340 an SN Modification Request message to the S-SN 106B to query a first reference C-SN configuration using a specific IE (e.g., SCG Configuration Query or a specifically defined IE for continuous CPAC, such as a Reference C-SN Configuration Query). The S-SN 106B, in response, transmits 342 an SN Modification Request Acknowledge message, including the first reference C-SN configuration, to the MN 104A. In some implementations, the first reference C-SN configuration is the first SN configuration. In other implementations, the first reference C-SN configuration is different from the first SN configuration. In yet other implementations, the first reference C-SN configuration is a subset of the first SN configuration. In some implementations, the first reference C-SN configuration is a full configuration. In other implementations, the first reference C-SN configuration is a delta configuration that augments the first SN configuration. In some implementations, the first reference C-SN configuration includes a reference CU configuration and a reference C-DU configuration.

The MN 104A transmits 305 an SN Addition Request message to the CU 172 of the C-SN 106A, similar to the event 304, and including the first reference C-SN configuration obtained in the event 342 from the S-SN 106B. The CU 172 of the C-SN 106A performs one or more 390 selective activation preparation procedure(s) as described in FIG. 3A to acquire C-DU configuration(s). In some implementations, the CU 172 of the C-SN 106A generates 376 C-SN configuration(s) and/or a second reference C-SN configuration, as described in FIG. 3A. In some implementations, the CU 172 of the C-SN 106A does not generate a second reference C-SN configuration as the CU 172 adopts the first reference C-SN configuration. The DU 174 of the C-SN 106A in such implementations does not generate a second reference C-DU configuration as the DU 174 adopts the first reference C-DU configuration. The CU 172 of the C-SN 106A, in response, transmits 307 an SN Addition Request Acknowledge message to the MN 104A, including M₁ C-SN configuration(s) based on the reference C-SN configuration, similar to the event 306. In some implementations, each of the M₁ C-SN configuration(s) is a delta configuration augmenting the first reference C-SN configuration from the S-SN 106B. In some implementations, the C-SN 106A refrains from including a second reference C-SN configuration in the SN Addition Request Acknowledge message in the event 307. The MN 104A performs 392 an RRC reconfiguration procedure with the UE 102, as described in FIG. 3A. In cases where early data forwarding is needed, the MN 104A transmits 344 an interface message (e.g., Xn-U Address Indication or Data Address Indication message) to the S-SN 106B. The S-SN 106B then transmits 346 an Early Status Transfer message to the MN 104A, and the MN 104A then transmits 314 an Early Status Transfer message to the CU 172 of the C-SN 106A.

In some implementations, based on the determination to perform continuous CPAC, the MN 104A also determines to configure an additional N−1 C-SN(s) for the MN-initiated CPC, as described in FIG. 3A. N is a positive integer larger than 1. The interactions between the MN 104A, the C-SN 2, . . . , N, and the UE 102 are similar to the interactions between the MN 104A, the C-SN 1, and the UE 102, as described above for the events 305, 307, and 392, and as described in FIG. 3A.

Similar to FIG. 3A, the UE 102 later detects 316 that a condition for connecting to the first C-PSCell is met and performs a random access procedure on the first C-PSCell in response to the detection with the DU 174 of the C-SN 106A. The UE 102, MN 104A, and C-SN 106A perform the CPAC execution procedure 394. After (e.g., in response to) the procedure 394, the MN 104A transmits 348 an SN Release Request message (e.g., SgNB Release Request or S-Node Release Request message) for the UE 102 to the S-SN 106B. The S-SN 106B, in response, stops communicating with the UE 102 and transmits 350 an SN Release Request Acknowledge message (e.g., SgNB Release Request Acknowledge or S-Node Release Request Acknowledge message) to the MN 104A. In some implementations, if the S-SN 106B has prepared a C-SN configuration for continuous CPAC, the MN 104A includes, in the SN Release Request message, an indicator or a cause value indicating that the SN Release procedure concerns continuous CPAC. The S-SN 106B therefore does not expect a follow-up UE Context Release procedure from the MN 104A (i.e., the MN 104A does not transmit a UE Context Release message to the S-SN 106B after the SN Release Request message). Upon receiving the SN Release Request message, indicator, or cause value, the S-SN 106B keeps the UE context and/or the UE-associated signaling connections between MN 104A and S-SN 106B for UE 102. In some cases where data forwarding is needed, the MN 104A transmits 351 an interface message (e.g., Xn-U Address Indication or Data Address Indication message) to the S-SN 106B. In some implementations, the S-SN 106B then transmits 352 an SN Status Transfer (e.g., sequence number status transfer) message to the MN 104A, and the MN 104A then, in some implementations, transmits 334 an SN Status Transfer (e.g., sequence number status transfer) message to the CU 172 of the C-SN 106A. In some implementations, for example, if the S-SN 106B has not prepared a C-SN configuration for continuous CPAC, the MN 104A transmits 356 a UE Context Release message to the S-SN 106B. The events 348, 350, 351, 352, 334, and 356 can be collectively referred to as an SN Release and SN Status Transfer (e.g., sequence number status transfer) procedure 396.

FIG. 3C depicts a scenario 300C (i.e., an SN-initiated conditional SN change for continuous CPC) similar to FIGS. 3A and 3B. The differences between FIG. 3C and FIGS. 3A and 3B are described below.

The S-SN 106B determines to initiate a conditional SN change (preparation) procedure for one or more C-SNs for continuous CPC. In some implementations, the S-SN 106B makes the determination based on measurement result(s) from the UE 102, for example. In some implementations, the UE 102 performs measurements on cells of the one or more C-SNs and transmits the measurement result(s) to the S-SN 106B in accordance with a measurement configuration in the first SN configuration. In response to the determination, the S-SN 106B transmits 303 an SN Change Required message including a Target SN ID of the C-SN 106A, a CG-Config IE for the C-SN 106A, and a first reference C-SN configuration. In some implementations, the S-SN 106B includes, in the SN Change Required message, CPC information for the C-SN 106A. For example, the CPC information (e.g., Conditional PSCell Change Information Required IE) includes an IE indicating the maximum number of PSCells that the C-SN 106A is to prepare. In such cases, the S-SN 106B includes the CG-Config IE in the CPC information. The first reference C-SN configuration in the SN Change Required message 303 is similar to the first reference C-SN configuration in the event 342. In some implementations, the S-SB 106B includes the first reference C-SN configuration in the CG-Config IE. In other implementations, the S-SN 106B includes the first reference C-SN configuration in an X2AP/XnAP IE of the SN Change Required message, different from an X2AP/XnAP IE that carries the CG-Config IE. In some implementations, the SN Change Required message includes a second indication (e.g., Selective Activation Indication IE) for continuous CPC for the UE 102. In some implementations, the S-SN 106B includes, in the CG-Config IE, triggering condition configuration(s) configuring the condition for the UE 102 to detect in the event 316.

After receiving the SN Change Required message, the MN 104A transmits 305C an SN Addition Request message to the CU 172 of the C-SN 106A, similar to the event 304 or 305. In the scenario 300A and 300B, the MN 104A derives an ID of the C-SN 106A based on the measurement results (e.g., received from the UE 102) and association information preconfigured in the MN 104A. For example, the association information indicates which cell is associated with which base station. In the scenario 300C, the MN 104A transmits the SN Addition Request message 305 to the C-SN 106A based on the Target SN ID of the C-SN 106A. In some implementations, the MN 104A generates an inter-node RRC message (i.e., CG-ConfigInfo IE), based on the CG-Config IE, and includes the CG-ConfigInfo IE in the SN Addition Request message. In some implementations, the CG-Config IE includes (i) a candidateCellInfoListSN IE including the measurement results for one or more cells (e.g., cell(s) 126A and/or 126C) of the C-SN 106A and/or (ii) a candidateCellListCPC IE indicating one or more cells (e.g., cell(s) 126A and/or 126C) that the S-SN 106B proposes for the C-SN 106A to consider as C-PSCell(s). The MN 104A includes the candidateCellInfoListSN IE and/or candidateCellListCPC IE in the CG-ConfigInfo IE. In some implementations, the CG-Config IE includes triggering condition configuration(s) (e.g., CondReconfigExecCondSCG IE(s)) for connecting the one or more cells. Alternatively, the MN 104A includes the triggering condition configuration(s) in a separate X2AP/XnAP IE of the SN Addition Request message. In other implementations, the MN 104A refrains from including the triggering condition(s) in the SN Addition Request message.

In some implementations, the MN 104A includes the first reference C-SN configuration in the SN Addition Request message in the event 305C, as described for the event 304 or 305. In some implementations, the MN 104A includes a first indication (e.g., Selective Activation Indication IE) for continuous CPAC in the SN Addition Request message in the event 305C based on or in response to the second indication. In some implementations, if the MN 104A does not support the SN-initiated conditional SN change (preparation) procedure for continuous CPC and receives an SN Change Required message for continuous CPAC from an SN (e.g., the SN Change Required message in the event 303), the MN 104A transmits an SN Change Refuse message to the SN, (e.g., the S-SN 106B). In some such cases, the MN 104A supports the SN-initiated conditional SN change (preparation) procedure for non-continuous CPC (e.g., in 3GPP CPC).

In some implementations, the S-SN 106B is allowed to initiate such conditional SN change (preparation) procedure for continuous CPC with the MN 104A because the S-SN 106B receives an SN Addition Request message or an SN Modification Request message, including an indication (e.g., Selective Activation Indication IE), from the MN 104A before or during the event 301. Based on the indication, the S-SN 106B determines that the MN 104A allows the S-SN 106B to initiate an SN-initiated conditional SN change (preparation) procedure for continuous CPC with the MN 104A. Thus, the S-SN 106B determines to transmit or transmits the SN Changed Required message in the event 303. If the S-SN 106B does not receive the indication, the S-SN 106B refrains from initiating an SN-initiated conditional SN change (preparation) procedure for continuous CPC with the MN 104A. In such cases, the S-SN 106B refrains from transmitting an SN Change Required message similar to the message in the event 303.

The CU 172 of the C-SN 106A performs one or more 390 selective activation preparation procedure(s), as described in FIG. 3A, to acquire C-DU configuration(s). In some implementations, the CU 172 of the C-SN 106A generates 376 C-SN configuration(s) and/or a second reference C-SN configuration, as described in FIG. 3A. In some implementations, the CU 172 of the C-SN 106A generates 376 C-SN configuration(s) and/or a second reference C-SN configuration, as described in FIG. 3A. The CU 172 of the C-SN 106A, in response to the SN Addition Request message, transmits 307 an SN Addition Request Acknowledge message to the MN 104A, including M₁ C-SN configuration(s), similar to the event 306. The MN 104A then transmits the M₁ C-SN configuration(s) to the UE 102 in the procedure 310. In some implementations, based on the reference C-SN configuration, the C-SN 106A generates each of the M₁ C-SN configuration(s) as a delta configuration augmenting the reference C-SN configuration. Unlike the scenarios 300A and 300B, in the RRC reconfiguration message of the procedure 392, each of the conditional (re)configuration field(s)/IE(s) includes the triggering condition configuration received from the S-SN 106B. After receiving the SN Addition Request Acknowledge message or after or while performing the procedure 392 with the UE 102, the MN 104A transmits 311 an SN Change Confirm message to the S-SN 106B.

In some implementations, the Target SN ID(s) include ID(s) of the C-SN(s) 2, . . . , N for the SN-initiated conditional SN change (preparation) procedure for continuous CPC with the C-SN(s) 2, . . . , N. Thus, in some implementations, the MN 104A transmits an SN Addition Request message to each of the C-SN(s) 2, . . . , N, as described above.

Turning to FIGS. 4A and 4B, scenarios 400A and 400B may each be similar to any one of the scenarios 300A-300C. However, the scenarios 400A and 400B involve an intra-base station CPC while the scenarios 300A-300C concern CPA or inter-base station CPC.

FIG. 4A depicts a scenario 400A (i.e., an intra-SN continues CPC), in which the UE 102 initially operates 402 in DC with the MN 104A and SN 106A and communicates with the S-DU 174A and the CU 172 of the SN 106A via a PSCell 126A in accordance with a first SN configuration, similar to the event 301. In some implementations, the first SN configuration includes a first CU configuration (i.e., a serving CU configuration) that the UE 102 uses to communicate with the CU 172 via the S-DU 174A and a first DU configuration (i.e., a serving DU configuration or an S-DU configuration) that the UE 102 uses to communicate with the S-DU 174A on the cell 126A.

At a later time, the CU 172 of the SN 106A determines to configure C-PSCells 1, . . . , M₁, where M₁ is a positive integer, to the UE 102 for intra-SN continuous CPC at the T-DU 174B. In some implementations, the CU 172 of the SN 106A makes the determination based on measurement result(s) from the UE 102, for example. In some implementations, the UE 102 performs measurements on cells of the SN 106A and transmits the measurement result(s) to the SN 106A in accordance with a measurement configuration in the first SN configuration. In some implementations, the UE 102 transmits 462 a measurement report, including the measurement results, to the MN 104A. In some implementations, the UE 102 transmits the measurement report in an ULInformationTransferMRDC message to the MN 104A. The MN 104A then transmits 464 the measurement report to the CU 172 of the SN 106A. In some implementations, the MN 104A transmits the measurement report of the event 464 in an RRC Transfer message to the CU 172 of the SN 106A. In other implementations, the UE 102 transmits 465 a measurement report to the S-DU 174A of the SN 106A. The S-DU 174A then transmits 467 the measurement report in a DU-to-CU message to the CU 172. In some implementations, the DU-to-CU message is a UL RRC Message Transfer message. In some implementations, in response to the determination, the CU 172 and S-DU 174A of the SN 106A, the MN 104A, and the UE 102 perform 480, in addition to the event 490, a selective activation preparation procedure similar to the event 380, as described in the FIG. 3A, to prepare one or more C-DU or C-SN configuration(s) served by the S-DU 174A. In some implementations, the first reference C-DU configuration is the same as the first DU configuration. The event 480 does not include events similar to the events 306, 315, or 332, as the SN 106A operates in DC with the MN 104A already for the UE 102. The CU 172 of the SN 106A transmits the RRC reconfiguration message, including the C-SN configuration(s), to the MN 104A using an SN Modification Required message instead of an SN Addition Request Acknowledge message as in FIG. 3A. The CU 172 of the SN 106A performs the selective activation preparation procedure(s) with the S-DU 174A using the UE Context Modification Request message and the UE Context Modification Response message.

The CU 172 of the SN 106A performs 490 one or more selective activation preparation procedure(s) with the T-DU 174B to acquire the M₁ C-DU configuration(s), similar to the event 390. In some implementations, the first reference C-DU configuration are the same as the first DU configuration. In some implementations, the CU 172 of the SN 106A generates 476 C-SN configuration(s) and/or a second reference C-SN configuration, as described in the event 376 in the FIG. 3A. The CU 172 of the SN 106A generates a first SN RRC reconfiguration message, including the M₁ C-SN configuration(s) (i.e., C-SN configuration(s) 1, . . . , M₁) and/or the reference C-SN configuration, similar to the event 308, and transmits 406 the first SN RRC reconfiguration message to the MN 104A. The C-SN configuration(s) 1, . . . , M₁ configure or are associated with the C-PSCells 1, . . . , M₁, respectively. In some implementations, the reference C-SN configuration included in the first SN RRC reconfiguration message is the first reference C-SN configuration that the CU 172 of the SN 106A generates based on the first reference C-DU configuration, as described in FIG. 3A. In other implementations, the reference C-SN configuration included in the first SN RRC reconfiguration message is the second reference C-SN configuration that the CU 172 of the SN 106A generates based on the second reference C-DU configuration, as described in FIG. 3A. In some implementations, each of the MIC-SN configuration(s) is a delta configuration augmenting the reference C-SN configuration, and each of the M₁ C-DU configuration(s) is a delta configuration augmenting the reference C-DU configuration. In some implementations, the reference C-SN configuration is the first SN configuration, and the reference C-DU configuration is the first DU configuration. In other implementations, the reference C-SN configuration is different from the first SN configuration, and the reference C-DU configuration is different from the first DU configuration. In yet other implementations, the reference C-SN configuration is a subset of the first SN configuration, and the reference C-DU configuration is a subset of the first DU configuration. In some implementations, the reference C-SN configuration is a full configuration. In some implementations, the reference C-DU configuration is a full configuration. In other implementations, the reference C-SN configuration is a delta configuration that augments the first SN configuration and the reference C-DU configuration is a delta configuration that augments the first DU configuration. In some implementations, the CU 172 of the SN 106A transmits an SN message (e.g., SN Modification Required message), including the first SN RRC reconfiguration message, to the MN 104A in the event 406. The MN 104A in turn transmits 408 the first SN RRC reconfiguration message to the UE 102. The UE 102, in response to the SN RRC reconfiguration message, the UE 102 transmits 410 a first SN RRC reconfiguration complete message to the MN 104A, which in turn transmits 412 the first SN RRC reconfiguration complete message to the CU 172 of the SN 106A. In some implementations, the MN 104A includes the first SN RRC reconfiguration complete message in the event 412 in an SN Reconfiguration Complete message.

In some implementations, the MN 104A generates an MN RRC message (e.g., RRC reconfiguration message), including the first SN RRC reconfiguration message, and transmits the MN RRC message to the UE 102 in the event 408. In such cases, the UE 102 transmits an MN RRC response message (e.g., RRC reconfiguration complete message), including the first SN RRC reconfiguration complete message, to the MN 104A in the event 410 in response to the MN RRC message.

In some implementations, the UE 102 later detects 416 that a condition for connecting to a first C-PSCell (e.g., the C-PSCell 1) is met. In response to the detection, the UE 102 performs 418 a random access procedure with the T-DU 174B of the SN 106A via the first C-PSCell. The UE 102 performs the random access procedure in accordance with the random access configurations of the C-DU configuration and/or the reference C-DU configuration. The UE 102 transmits 422 a second SN RRC reconfiguration complete message to the MN 104A, which in turn transmits 424 the second SN RRC reconfiguration complete message to the CU 172 of the SN 106A. In some implementations, the second SN RRC reconfiguration complete message includes a configuration ID indicating the C-SN configuration 1 for the first C-PSCell to the MN 104A. In some implementations, the UE 102 includes the second SN RRC reconfiguration complete message in a ULInformationTransferMRDC message. In some implementations, the MN 104A transmits an SN message (e.g., RRC Transfer message), including the second SN RRC reconfiguration complete message, to the SN 106A in the event 424. The T-DU 174B of the SN 106A after the random access procedure sends 420 an Access Success message to the CU 172 of the SN 106A. The Access Success message includes the Cell ID that the UE 102 accesses successfully.

After successfully completing the random access procedure, the UE 102 in DC communicates 436 with the MN 104A and the SN 106A, and the UE 102 communicates with the SN 106A via the first C-PSCell in accordance with the C-SN configuration. Specifically, the UE 102 communicates with the T-DU 174B of the SN 106A via the first C-PSCell in accordance with the C-DU configuration that configures the first C-PSCell and/or the reference C-DU configuration. The events 418, 420, 422, 424, and 436 can be collectively referred to as a (intra-SN) CPC execution procedure 494. In some implementations, the CU 172 of the SN 106A transmits 426 a UE Context Modification Request message to the S-DU 174A to stop data transmission for the UE 102. The S-DU 174A in response transmits 428 a UE Context Modification Response message to the CU 172. In some implementations, the S-DU 174A is configured with the selective activation preparation procedure, as described in event 480. The CU 172 in such implementations refrains from transmitting 430 a UE Context Release Command message to the S-DU 174A following the UE context modification procedure. In other implementations, the S-DU 174A is not configured with the selective activation preparation procedure, as described in event 480. The CU 172 in such implementations transmits 430 a UE Context Release Command message to the S-DU 174A following the UE context modification procedure. The S-DU 174A releases the UE context and resources reserved for the UE 102 and transmits 432 a UE Context Release Complete message to the CU 172. The events 426, 428, 430, and 432 can be collectively referred to as the UE context release procedure 498. In some implementations, the UE 102 later detects 438 that a condition for connecting to a second C-PSCell is met, similar to the event 418. The UE 102, MN 104A, and SN 106A perform 495 the (intra-SN) CPC execution procedure for the second C-PSCell similar to the event 494.

Referring next to FIG. 4B. FIG. 4B depicts a scenario 400B similar to the scenario 400A and the differences are described below. After the one or more selective activation preparation procedure(s) 490 and the C-SN configuration(s) and/or the reference C-SN configuration generating procedure 476, the CU 172 of the SN 106A transmits 407 the first SN RRC reconfiguration message, similar to the event 406, but to the S-DU 174A (i.e., the source or serving DU) instead of the MN 104A. In some implementations, the CU 172 transmits the first SN RRC reconfiguration message in a DL RRC Message Transfer message to the S-DU 174A at the event 407. The S-DU 174A subsequently transmits 409 the first SN RRC reconfiguration complete message to the UE 102. The UE 102, in response, transmits 411 the first RRC reconfiguration complete message to the S-DU 174A of the SN 106A. The S-DU 174A transmits 413 the first RRC reconfiguration complete message to the CU 172 of the SN 106A. In some implementations, the S-DU 174A transmits the first RRC reconfiguration complete message in a UL RRC Message Transfer message to the CU 172 at the event 413. In response to the detection 416, the UE 102 performs 418 the random access procedure with the T-DU 174B of the SN 106A, via the first C-PSCell, and transmits 421 the second SN RRC reconfiguration complete message to the T-DU 174B of the SN 106A directly (e.g., via the SRB3). The T-DU 174B transmits 423 the second SN RRC reconfiguration complete message to the CU 172 of the SN 106A. In some implementations, the T-DU 174B transmits the second SN RRC reconfiguration complete message in a UL RRC Message Transfer message to the CU 172.

The events 418, 420, 421, 423, and 436 can be collectively referred to as a (intra-SN) CPC execution procedure 496. In some implementations, the CU 172 and the S-DU 174A of the SN 106A perform 498 the UE context release procedure after the event 496. In some implementations, the UE 102 later detects 438 that a condition for connecting to a second C-37 PSCell is met, similar to the event 418. The UE 102, MN 104A, and SN 106A perform 497 the (intra-SN) CPC execution procedure for the second C-PSCell, similar to the event 496.

In some implementations, the SN 106A determines to update the reference C-SN configuration (i.e., a first reference C-SN configuration). In response to the determination, the CU 172 of the SN 106A performs a selective activation preparation procedure or a UE context modification procedure with the T-DU 174B to acquire the updated reference C-DU configuration and/or updated C-DU configuration(s). The CU 172 of the SN 106A further generates the updated reference C-SN configuration (i.e., a second reference C-SN configuration) and/or updated C-SN configuration(s) accordingly. The SN 106A transmits a second reference C-SN configuration and/or the updated C-SN configuration(s), similar to the event 406-408 or 407-409. In cases where the second reference C-SN configuration is a full configuration, the UE 102 replaces the first reference C-SN configuration with the second reference C-SN configuration. In cases where a condition for connecting to a C-PSCell is met, similar to the event 416 or 438, the UE 102 performs a random access procedure on the C-PSCell and applies the C-SN configuration, configuring or associated with the C-PSCell, and the second C-SN configuration to communicate with the SN 106A, similar to the events 418 and 436, 494, 495, 496, or 497.

In cases where the second reference C-SN configuration is a delta configuration, the UE 102 augments the first reference C-SN configuration with the second reference C-SN configuration to obtain an updated reference C-SN configuration. In cases where a condition for connecting to a C-PSCell is met, similar to event 416 or 438, the UE 102 performs a random access procedure on the C-PSCell and applies the C-SN configuration (e.g., configuring or associated with the C-PSCell) and the updated C-SN configuration to communicate with the SN 106A, similar to the event 418 and the event 436, 494, 495, 496, or 497, respectively.

After the UE 102 applies the C-SN configuration as described above, the applied C-SN configuration becomes an SN configuration (i.e., serving or source SN configuration) or a portion of the SN configuration. After (e.g., in response to) applying the C-SN configuration, the UE 102 refrains from removing the conditional (re)configuration field(s)/IE(s) associated with the reference C-SN configuration.

In some implementations, the SN 106A generates a C-SN configuration configuring a particular C-PSCell for non-continuous CPAC and transmits the C-SN configuration to the UE 102, similar to the events 406 and 408 or the event 409. In such cases, the C-SN configuration for non-continuous CPAC is not associated with a reference C-SN configuration. In cases where a condition for connecting to the particular C-PSCell is met, similar to the event 416 or 438, the UE 102 performs a random access procedure on the particular C-PSCell and applies the C-SN configuration to communicate with the SN 106A on the particular C-PSCell, similar to the event 318 and the event 336, 394, or 395, respectively. After applying the C-SN configuration, the UE 102 removes the conditional (re)configuration field(s)/IE(s).

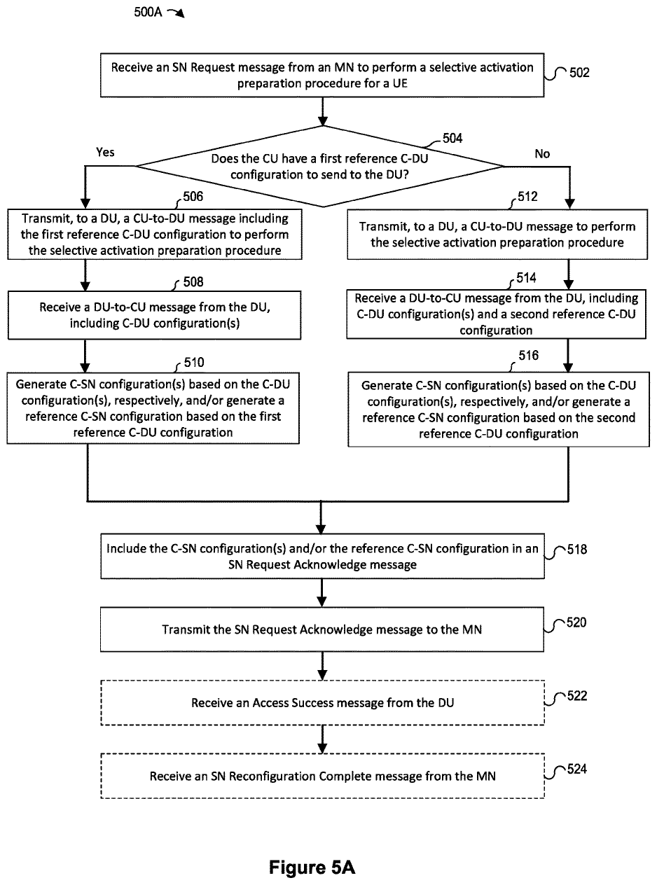

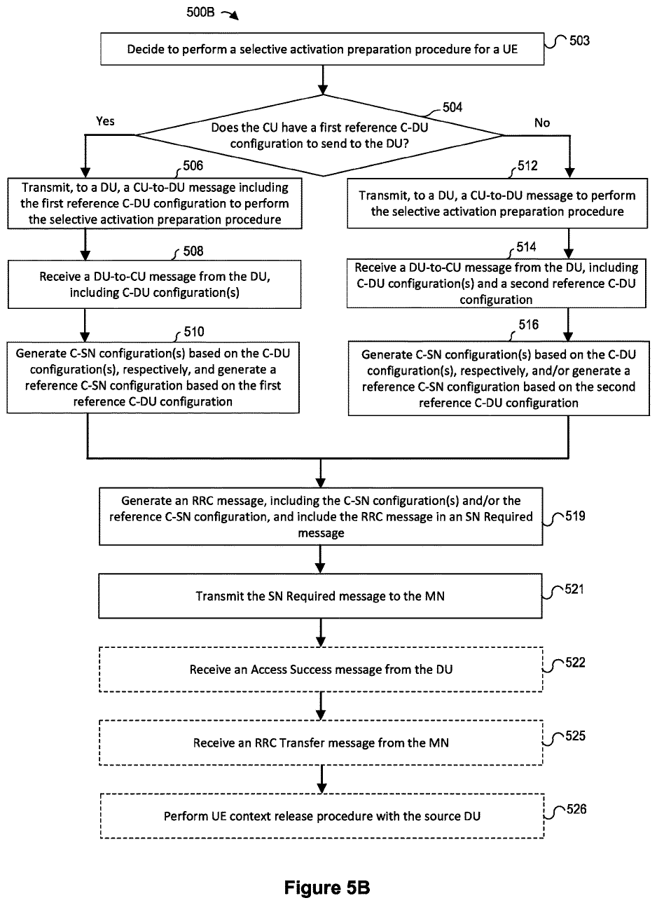

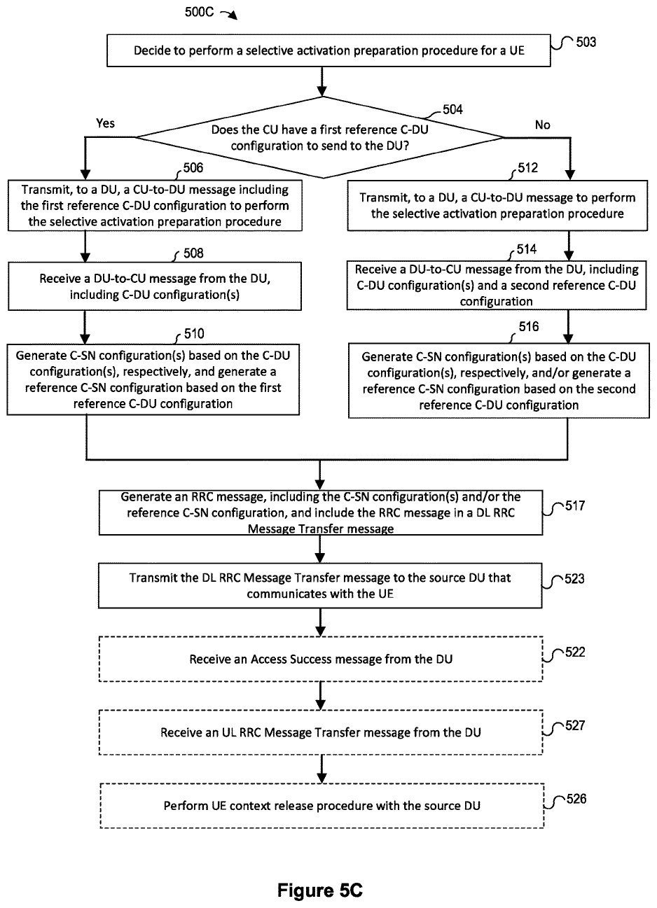

FIGS. 5A-13 are flow diagrams depicting example methods that a RAN node (e.g., the base station 104A, 104B, 106A, or 106B and/or components of the base station 104A, 104B, 106A, or 106B (e.g., the DU 174 of the C-SN 106A, CU 172 of the C-SN 106A, etc.)) can implement to support continuous CPAC/selective activation procedures in accordance with the techniques of this disclosure. As indicated at various points throughout this disclosure, the example methods depicted in FIGS. 5A-13 may be implemented during the scenarios 300A-300C and 400A-400B described above.

FIG. 5A illustrates a method 500A, which can be implemented by a CU of a C-SN (e.g., the CU 172 of the C-SN 106A), for performing a selective activation preparation procedure with a DU of the C-SN (e.g., the DU 174 of the C-SN 106A).

The method 500A begins at block 502, where the CU receives an SN Request message from an MN to perform a selective activation preparation procedure for a UE (e.g., event 304, 305, or 305C). The CU at block 504 determines whether it has a first reference C-DU configuration to send to the DU. If the CU has a first reference C-DU configuration, the flow proceeds to block 506, where the CU transmits, to a DU, a CU-to-DU message, including the first reference C-DU configuration, to perform the selective activation preparation procedure (e.g., event 372 or 390). The flow continues to block 508, where the CU receives a DU-to-CU message from the DU including C-DU configuration(s) (e.g., event 374 or 390). The flow continues to block 510, where the CU generates C-SN configuration(s) based on the C-DU configuration(s), respectively, and/or generates a reference C-SN configuration based on the first reference C-DU configuration. In some implementations, the CU refrains from generating a reference C-SN configuration based on the first reference C-DU configuration, as the CU already has the reference C-SN configuration. The flow then proceeds to block 518, where the CU includes the C-SN configuration(s) and/or the reference C-SN configuration in an SN Request Acknowledge message. The CU at block 520 transmits the SN Request Acknowledge message to the MN (e.g., event 306). In some implementations, the CU at block 522 receives an Access Success message from the DU (e.g., event 320). In some implementations, the CU at block 524 receives an SN Reconfiguration Complete message from the MN (e.g., event 324).

Otherwise, if the CU does not have a first reference C-DU configuration at block 504, the flow proceeds to block 512, where the CU transmits, to a DU, a CU-to-DU message to perform the selective activation preparation procedure (e.g., event 372 or 390). The flow continues to proceed to block 514, where the CU receives a DU-to-CU message from the DU, including C-DU configuration(s) and a second reference C-DU configuration. The CU at block 516 generates C-SN configuration(s) based on the C-DU configuration(s), respectively, and/or generates a reference C-SN configuration based on the second reference C-DU configuration.

The flow continues to proceed to blocks 518 and 520 and, in some implementations, proceeds to blocks 522 or 524 as described above.

In some implementations, the CU receives the first reference C-DU configuration from the SN Request message. In other implementations, the CU previously received the first reference C-DU configuration and currently stores (e.g., has) the first reference C-DU configuration. In yet further implementations, the CU generates the reference C-DU configuration.

In some implementations, the CU-to-DU message is a UE Context Setup Request message or a UE Context Modification Request message and the DU-to-CU message is a UE Context Setup Response message or a UE Context Modification Response message. In some implementations, the CU-to-DU message includes a selective activation indication.

FIG. 5B illustrates a method 500B similar to the method 500A, except that the method 500B refers to a CU of the SN (e.g., the CU 172 of the SN 106A) instead of a C-SN and includes blocks 503, 519, 521, 525, and 526 instead of blocks 502, 520, and 524. The selective activation preparation uses the SRB1 in the method 500B. At block 503, the CU decides to perform a selective activation preparation procedure for a UE (e.g., based on events 462-464 or 465-467). If the CU has a first reference C-DU configuration to send to the DU, the flow proceeds to blocks 506, 508, and 510. Otherwise, the flow proceeds to block 512, 514, and 516. At block 519 the CU generates an RRC message, including the C-SN configuration(s) and/or the reference C-SN configuration, and includes the RRC message in an SN Required message. At block 521, the CU transmits the SN Required message to the MN (e.g., event 406). In some implementations, at block 525, the CU receives an RRC Transfer message from the MN (e.g., event 424). In some implementations, at block 526, the CU performs a UE context release procedure with the source DU (e.g., event 498).

In some implementations, the SN Required message is an SN Modification Required message. Similar to FIG. 5A, in some implementations, the CU-to-DU message is a UE Context Setup Request message or a UE Context Modification Request message and the DU-to-CU message is a UE Context Setup Response message or a UE Context Modification Response message. In some implementations, the CU-to-DU message includes a selective activation indication.

FIG. 5C illustrates a method 500C similar to the method(s) 500B or 500A, except that the method 500C refers to a CU of the SN (e.g., the CU 172 of the SN 106A) and includes blocks 517, 523, and 527 instead of blocks 519, 521, and 525 of the method 500B. The selective activation preparation uses the SRB3, and the MN is, in some implementations, not involved in the method 500C. The flow proceeds from blocks 510 or 516 to block 517, where the CU generates an RRC message, including the C-SN configuration(s) and/or the reference C-SN configuration, and includes the RRC message in a DL RRC Message Transfer message. At block 523, the CU transmits the DL RRC Message Transfer message to the source DU (e.g., event 407). In some implementations, the flow proceeds to blocks 522, 527, and 526. At block 527, the CU receives an UL RRC Message Transfer message from the DU (e.g., event 423).

Similar to FIGS. 5A and 5B, in some implementations, the CU-to-DU message is a UE Context Setup Request message or a UE Context Modification Request message and the DU-to-CU message is a UE Context Setup Response message or a UE Context Modification Response message. In some implementations, the CU-to-DU message includes a selective activation indication.

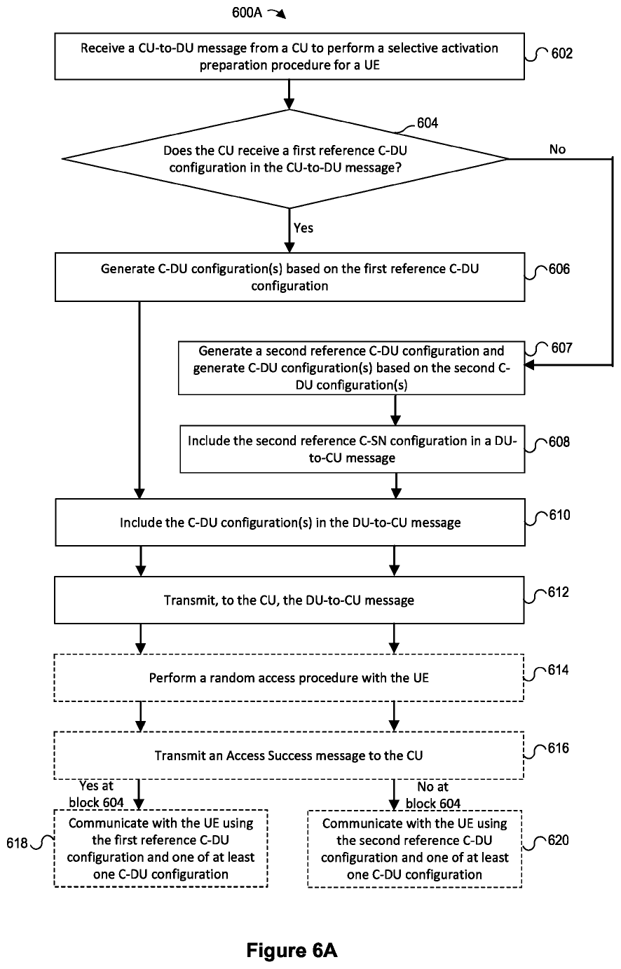

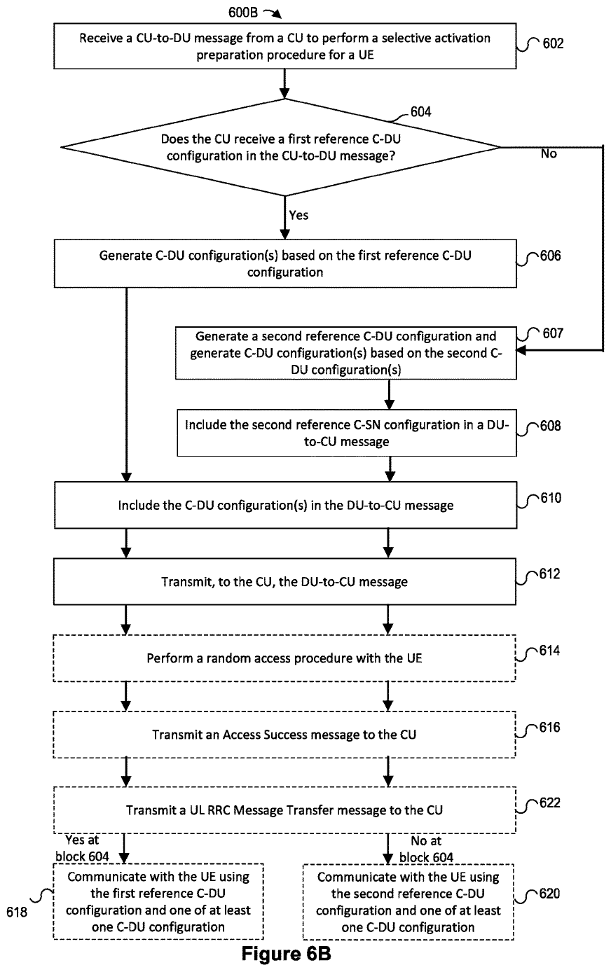

FIG. 6A illustrates a method 600A, which a DU of a (C-)SN (e.g., the DU 174 of the (C-)SN 106A) can implement, for performing a selective activation preparation procedure with a CU of the (C-)SN (e.g., the CU 172 of the (C-)SN 106A).

The method 600A begins at block 602, where the DU receives a CU-to-DU message from a CU to perform a selective activation preparation procedure for a UE (e.g., event 372, 390 or 490). The CU at block 604 determines whether the CU receives a first reference C-DU configuration in the CU-to-DU message. If the CU receives a first reference C-DU configuration, the flow proceeds to block 606, where the DU generates C-DU configuration(s) based on the first reference C-DU configuration. The flow continues to block 610, where the DU includes the C-DU configuration(s) in the DU-to-CU message. At block 612, the DU transmits, to the CU, the DU-to-CU message (e.g., event 374, 390, or 490). In some implementations, at block 614, the DU performs a random access procedure with the UE (e.g., event 318 or 418). In some implementations, at block 616, the DU transmits an Access Success message to the CU (e.g., event 320 or 420). The flow continues to block 618, where, in some implementations, the DU communicates with the UE using the first reference C-DU configuration and one of at least one C-DU configuration (e.g., event 336 or 436).

Otherwise, if at block 604 the DU does not receive a first reference C-DU configuration in the CU-to-DU message, the flow proceeds to block 607, where the DU generates a second reference C-DU configuration and generates C-DU configuration(s) based on the second C-DU configuration(s). At block 608, the DU includes the second reference C-SN configuration in a DU-to-CU message. The flow continues to blocks 610 and 612, and, in some implementations continues to blocks 614, 616, and 620. At block 620, the DU communicates with the UE using the second reference C-DU configuration and one of at least one C-DU configuration (e.g., event 336 or 436).

In some implementations, the CU-to-DU message is a UE Context Setup Request message or a UE Context Modification Request message and the DU-to-CU message is a UE Context Setup Response message or a UE Context Modification Response message. In some implementations, the CU-to-DU message includes a selective activation indication.

FIG. 6B illustrates a method 600B similar to the method 600A, except that the method 600B refers to a DU of the SN (e.g., the DU 174 of the SN 106A) and includes an extra optional block 622. The selective activation preparation uses SRB3 and the MN is, in some implementations, not involved in the method 600B. In some implementations, the flow proceeds from block 616 to block 622 before going to blocks 618 or 620. At block 622, the DU transmits an UL RRC Message Transfer message to the CU (e.g., event 423).

Similar to FIG. 6A, in some implementations, the CU-to-DU message is a UE Context Setup Request message or a UE Context Modification Request message and the DU-to-CU message is a UE Context Setup Response message or a UE Context Modification Response message. In some implementations, the CU-to-DU message includes a selective activation indication.

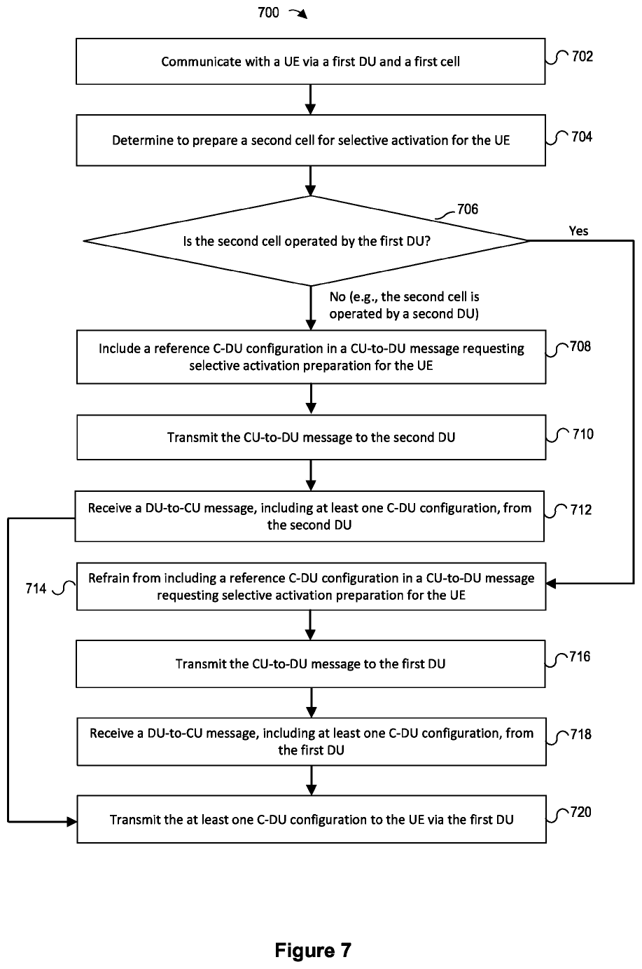

FIG. 7 illustrates a method 700, which a CU of an SN (e.g., the CU 172 of the SN 106A) can implement, for performing a selective activation preparation with a DU of the SN (e.g., the DU 174 of the SN 106A) for a UE (e.g., the UE 102).

The method 700 begins at block 702, where the CU communicates with a UE via a first DU and a first cell (e.g., event 401 or 402). The first cell is a serving cell. The CU at block 704 determines to prepare a second cell for selective activation for the UE (e.g., based on events 462-464 or events 465-467). The second cell is a non-serving cell. At block 706, the CU determines whether the first DU operates the second cell. If the CU determines that the first DU does not operate the second cell (i.e., the CU determines that a second DU operates the second cell) at block 706, the flow proceeds to block 708. At block 708, the CU includes a reference C-DU configuration in a CU-to-DU message requesting selective activation preparation for the UE (e.g., event 490). At block 710, the CU transmits the CU-to-DU message to the second DU. At block 712, the CU receives a DU-to-CU message, including at least one C-DU configuration, from the second DU UE (e.g., event 490).

Otherwise, if the CU determines that the first DU operates the second cell at block 706, the flow proceeds to block 714. At block 714, the CU refrains from including a reference C-DU configuration in a CU-to-DU message requesting selective activation preparation for the UE. At block 716, the CU transmits a CU-to-DU message to the first DU (e.g., event 490). At block 718, the CU receives a DU-to-CU message, including at least one C-DU configuration, from the first DU. The flow proceeds to block 720 from block 718 as well as block 712. At block 720, the CU transmits the at least one C-DU configuration to the UE via the first DU (e.g., events 407-409). Alternatively, the CU transmits the at least one C-DU configuration to the UE via a RAN node (e.g., events 406-408 or 306-308). In some implementations, the RAN node is another DU or base station.

In some implementations, the CU-to-DU message and DU-to-CU message are a UE Context Setup Request message and UE Context Setup Response message, respectively. In some implementations, the CU-to-DU message includes a selective activation indication.

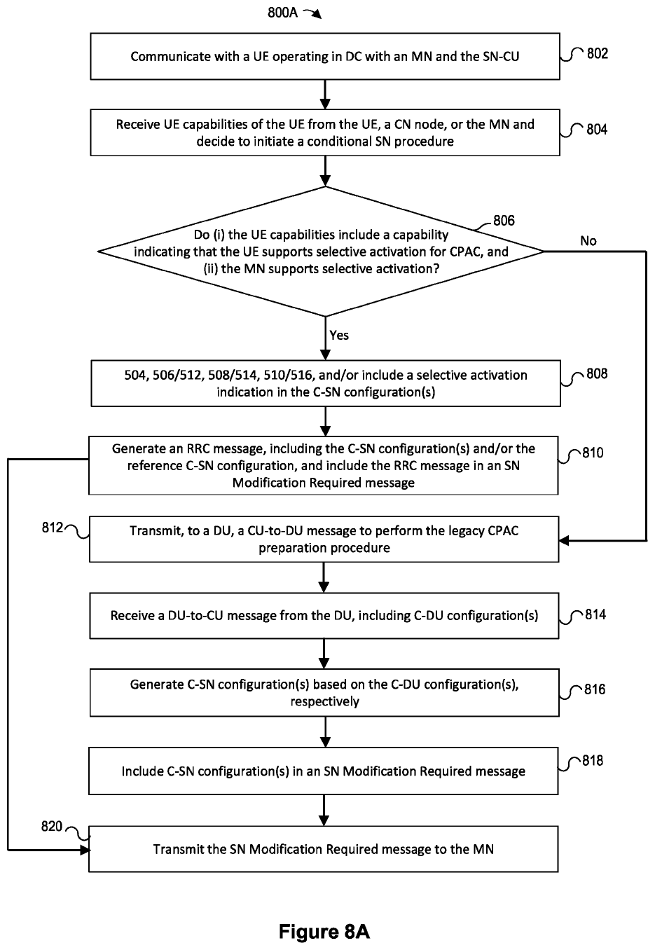

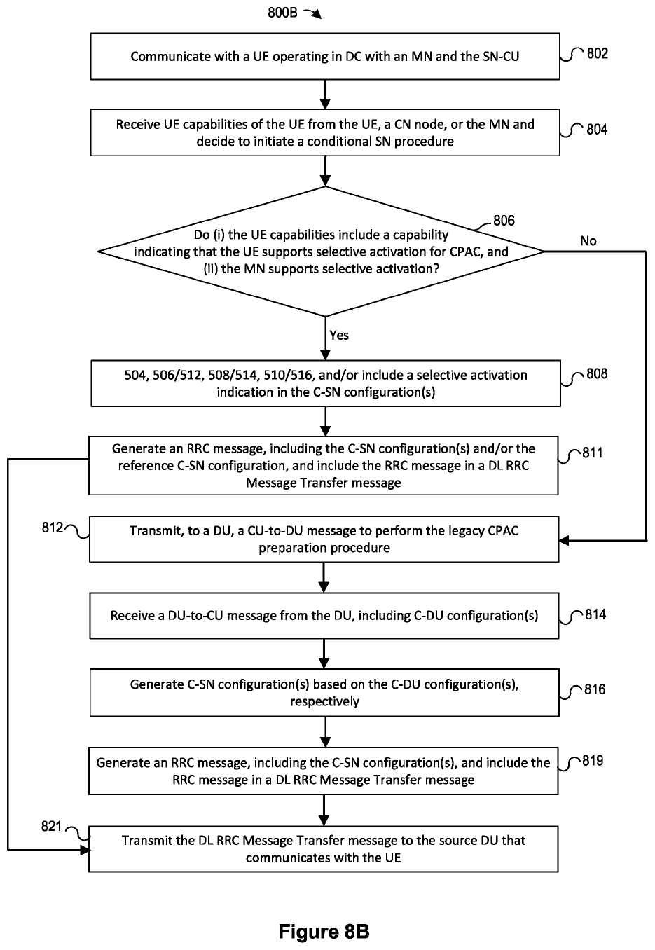

FIG. 8A illustrates a method 800A, which a CU of an SN (e.g., the CU 172 of the SN 106A) can implement, for performing a selective activation preparation procedure with a DU of the SN (e.g., the DU 174 of the SN 106A).

The method 800A begins at block 802, where the CU communicates with a UE operating in DC with an MN and the SN-CU (e.g., event 402). The CU at block 804 receives UE capabilities of the UE from the UE, a CN node, or the MN and determines to initiate a conditional SN procedure. The CU at block 806 determines whether (i) the UE capabilities include a capability indicating that the UE supports selective activation for CPAC and (ii) the MN supports selective activation. If the UE and the MN support selective activation, the flow proceeds to block 808, where the CU performs the actions described in blocks 504, 506/512, 508/514, and 510/516 and/or includes a selective activation indication in the C-SN configuration(s). The flow further proceeds to block 810, where the CU generates an RRC message including the C-SN configuration(s) and/or the reference C-SN configuration, and the CU includes the RRC message in an SN Modification Required message. Otherwise (i.e., either the UE or the MN does not support selective activation), the flow proceeds to block 812, where the CU transmits, to a DU, a CU-to-DU message to perform the legacy CPAC preparation procedure. The flow further proceeds to block 814, where the CU receives a DU-to-CU message from the DU, including C-DU configuration(s). At block 816, the CU generates C-SN configuration(s) based on the respective C-DU configuration(s). At block 818, the CU includes C-SN configuration(s) in an SN Modification Required message. The flow proceeds from block 818 or 810 to block 820, where the CU transmits the SN Modification Required message to the MN (e.g., event 406).

FIG. 8B illustrates a method 800B similar to the method 800A, except that the method 800B includes blocks 811, 819, and 821 instead of blocks 810, 818, and 820. The selective activation preparation uses the SRB3 and, in some implementations, the MN is not involved in the method 800B. If the UE and the MN support selective activation, the flow proceeds to block 808, where the CU performs the actions described in blocks 504, 506/512, 508/514, and 510/516 and/or includes a selective activation indication in the C-SN configuration(s). At block 811, the CU generates an RRC message, including the C-SN configuration(s) and/or the reference C-SN configuration, and includes the RRC message in a DL RRC Message Transfer message.

Otherwise, the flow proceeds from 806 to blocks 812, 814, 816, and 819. At block 819, the CU generates an RRC message, including the C-SN configuration(s), and includes the RRC message in a DL RRC Message Transfer message. The flow proceeds from block 819 or 811 to block 821, where the CU transmits the DL RRC Message Transfer message to the source DU that communicates with the UE (e.g., event 407).

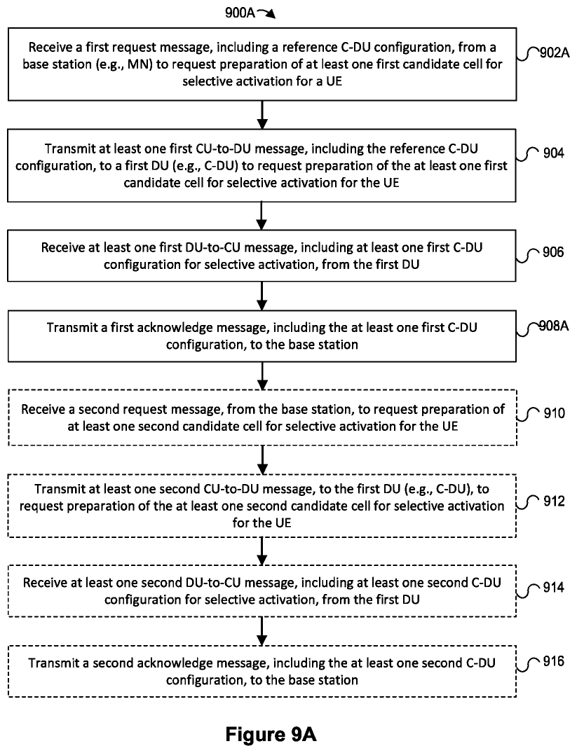

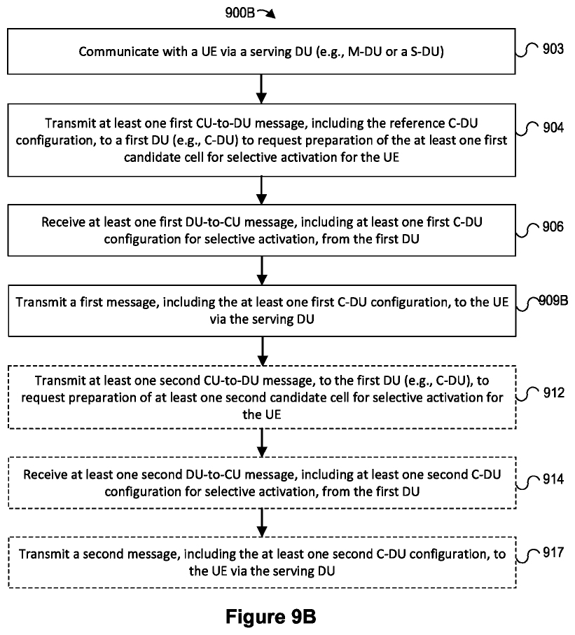

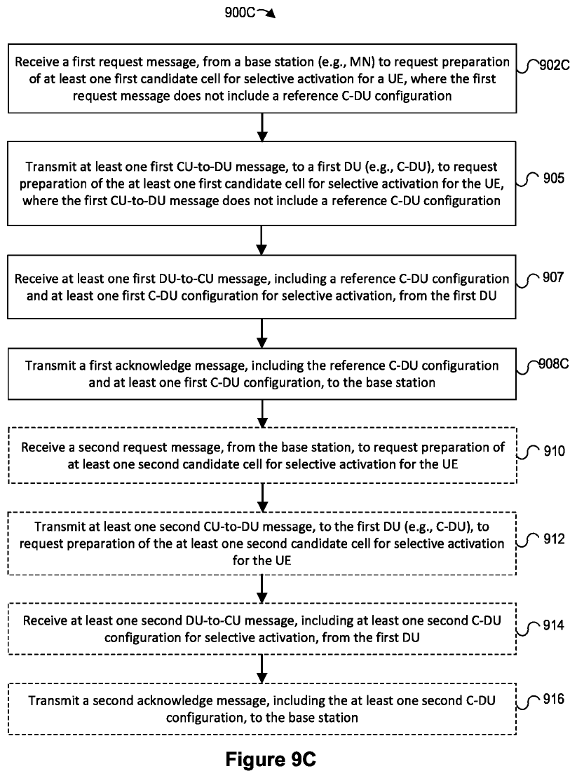

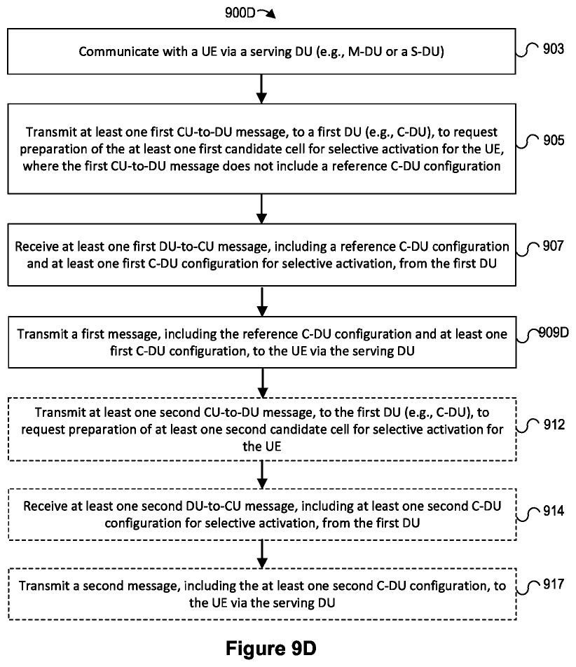

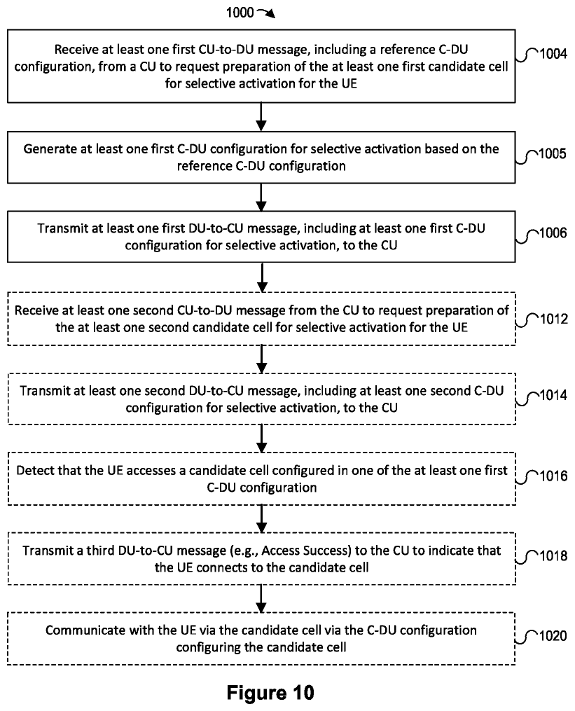

FIG. 9A illustrates a method 900A, which a CU of a C-SN (e.g., the CU 172 of the C-SN 106A) can implement, for performing a selective activation preparation procedure with a DU of the C-SN (e.g., the DU 174 of the C-SN 106A).

The method 900A begins at block 902A, where the CU receives a first request message, including a reference C-DU configuration to request preparation of at least one first candidate cell for selective activation for a UE, from a base station (e.g., MN) (e.g., event 304). At block 904, the CU transmits at least one first CU-to-DU message, including the reference C-DU configuration to request preparing the at least one first candidate cell for selective activation for the UE, to a first DU (e.g., C-DU) (e.g., event 372). At block 906, the CU receives at least one first DU-to-CU message, including at least one first C-DU configuration for selective activation, from the first DU (e.g., event 374). At block 908A, the CU transmits a first acknowledge message, including the at least one first C-DU configuration, to the base station (e.g., event 306). In some implementations, at block 910, the CU receives a second request message from the base station to request preparation of at least one second candidate cell for selective activation for the UE (e.g., event 304). In some implementations, at block 912, the CU transmits at least one second CU-to-DU message to the first DU (e.g., C-DU) to request preparation of the at least one second candidate cell for selective activation for the UE (e.g., event 372). In some implementations, at block 914, the CU receives at least one second DU-to-CU message, including at least one second C-DU configuration for selective activation, from the first DU (e.g., event 374). In some implementations, at block 916, the CU transmits a second acknowledge message, including the at least one second C-DU configuration, to the base station (e.g., event 306). In some implementations, the blocks 910 through 916 are optional.

Each of the at least one first DU-to-CU message responds to each of the at least one respective first CU-to-DU message. In some implementations, each of the at least one first C-DU configuration configures each of at least one respective first candidate cell. In some implementations, the first DU generates the at least one first C-DU configuration based on the reference C-DU configuration. In some implementations, the CU includes the reference C-DU configuration in the first CU-to-DU message and, in further implementations, does not include the reference C-DU in the rest of the at least one first CU-to-DU message.

Each of the at least one second DU-to-CU message responds to each of the at least one respective second CU-to-DU message. In some implementations, each of the at least one second C-DU configuration configures each of at least one respective second candidate cell. In some implementations, the first DU generates the at least one second C-DU configuration based on the reference C-DU configuration.

In some implementations, the first or the second request message is an SN Addition Request, an SN Modification Request, or a Handover Request message, and the first or second acknowledge message is an SN Addition Request Acknowledge, an SN Modification Request Acknowledge, or a Handover Request Acknowledge message.

FIG. 9B illustrates a method 900B similar to the method 900A. The selective activation preparation uses the SRB3, and, in some implementations, the MN is not involved in the method 900B. The method 900B begins at block 903, where the CU communicates with a UE via a serving DU (e.g., M-DU or a S-DU) (e.g., event 401). The flow proceeds to blocks 904 and 906 as described in the method 900A. The flow proceeds from block 906 to block 909B, where the CU transmits a first message, including the at least one first C-DU configuration, to the UE via the serving DU (e.g., event 407-409). In some implementations, the flow further proceeds to blocks 912 and 914 as described in the method 900A. The flow proceeds from block 914 to 917, where the CU transmits a second message, including the at least one second C-DU configuration, to the UE via the serving DU (e.g., event 407-409).

In some implementations, the first message and second message are RRC messages (e.g., RRC reconfiguration messages).

FIG. 9C illustrates a method 900C similar to the method(s) 900A or 900B. The method 900C begins at block 902C, where the CU receives a first request message from a base station (e.g., MN) to request preparation of at least one first candidate cell for selective activation for a UE, where the first request message does not include a reference C-DU configuration (e.g., event 304). At block 905, the CU transmits at least one first CU-to-DU message to a first DU (e.g., C-DU) to request preparation of the at least one first candidate cell for selective activation for the UE, where the first CU-to-DU message does not include a reference C-DU configuration (e.g., event 372, 390, or 490). At block 907, the CU receives at least one first DU-to-CU message, including a reference C-DU configuration and at least one first C-DU configuration for selective activation, from the first DU (e.g., event 374, 390, or 490). At block 908C, the CU transmits a first acknowledge message, including the reference C-DU configuration and at least one first C-DU configuration, to the base station (e.g., event 306). In some implementations, the flow proceeds from 908C to blocks 910, 912, 914, and 916 as described in method 900A. The blocks 910, 912, 914, and 916 are optional.

FIG. 9D illustrates a method 900D similar to the method(s) 900A, 900B, or 900C. The method 900D begins at block 903, where the CU communicates with a UE via a serving DU (e.g., M-DU or a S-DU) (e.g., event 401). At block 905, the CU transmits at least one first CU-to-DU message to a first DU (e.g., C-DU) to request preparation of the at least one first candidate cell for selective activation for the UE, where the first CU-to-DU message does not include a reference C-DU configuration (e.g., event 372, 390, or 490). At block 907, the CU receives at least one first DU-to-CU message, including a reference C-DU configuration and at least one first C-DU configuration for selective activation, from the first DU (e.g., event 374, 390, or 490). The flow proceeds from block 907 to block 909D, where the CU transmits a first message, including the reference C-DU configuration and at least one first C-DU configuration, to the UE via the serving DU (e.g., event 407-409). In some implementations, the flow proceeds from 909D to blocks 912, 914, and 917 as described in method 900D. The blocks 912, 914, and 917 are optional.

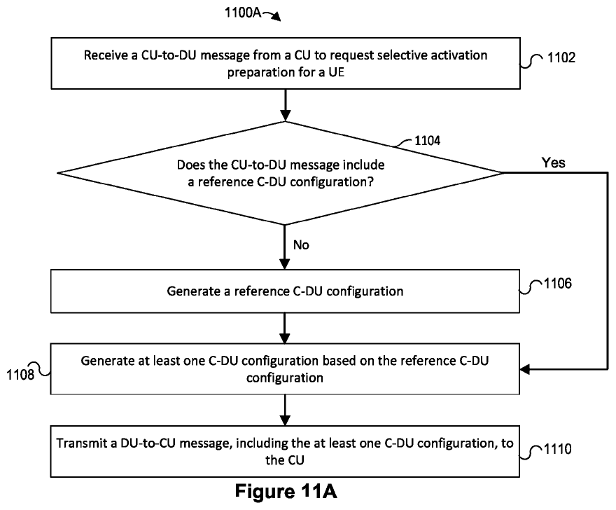

FIG. 10 illustrates a method 1000, which a DU of a (C-)SN (e.g., the DU 174 of the (C-)SN 106A) can implement, for performing a selective activation procedure with a CU of the (C-)SN (e.g., the CU 172 of the (C-)SN 106A).

The method 1000 begins at block 1004, where the DU receives at least one first CU-to-DU message, including a reference C-DU configuration, from a CU to request preparation of the at least one first candidate cell for selective activation for the UE (e.g., event 372, 390, or 490). The DU at block 1005 generates at least one first C-DU configuration for selective activation based on the reference C-DU configuration. At block 1006, the DU transmits at least one first DU-to-CU message, including at least one first C-DU configuration for selective activation, to the CU (e.g., event 374, 390, or 490). In some implementations, the flow proceeds to blocks 1012, 1014, 1016, 1018, and 1020. In some implementations, at block 1012, the DU receives at least one second CU-to-DU message from the CU to request preparation of the at least one second candidate cell for selective activation for the UE (e.g., event 372, 390, or 490). In some implementations, at block 104, the DU transmits at least one second DU-to-CU message, including at least one second C-DU configuration for selective activation, to the CU (e.g., event 374, 390, or 490). In some implementations, at block 1016, the DU detects that the UE accesses a candidate cell configured in one of the at least one first C-DU configuration (e.g., event 318 or 418). In some implementations, at block 1018, the DU transmits a third DU-to-CU message (e.g., Access Success) to the CU to indicate that the UE connects to the candidate cell (e.g., event 320 or 420). At block 1020, the DU communicates with the UE via the candidate cell via the C-DU configuration configuring the candidate cell.

In some implementations, the first or the second CU-to-DU message is a UE Context Setup Request message or a UE Context Modification Request message, and the first or the second DU-to-CU message is a UE Context Setup Response message or a UE Context Modification Response message.

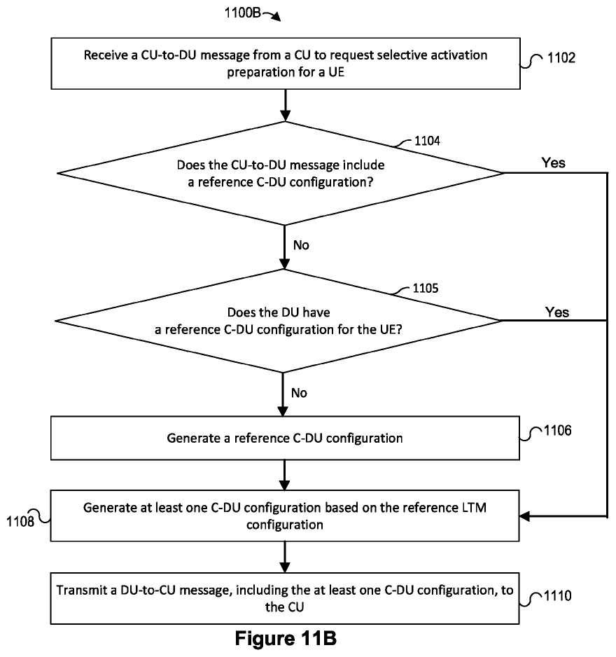

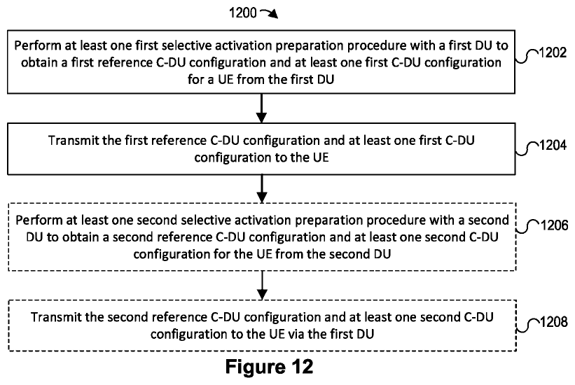

FIG. 11A illustrates a method 1100A, which a DU of a (C-)SN (e.g., the DU 174 of the (C-)SN 106A) can implement, for performing a selective activation procedure with a CU of the (C-)SN (e.g., the CU 172 of the (C-)SN 106A).

The method 1100A begins at block 1102, where the DU receives a CU-to-DU message from a CU to request selective activation preparation for the UE (e.g., events 372, 390, or 490). At block 1104, the DU determines whether the CU-to-DU message includes a reference C-DU configuration. If the DU determines that the CU-to-DU message does not include a reference C-DU configuration at block 1104, the flow proceeds to block 1106. At block 1106, the DU generates a reference C-DU configuration. At block 1108, the DU generates at least one C-DU configuration based on the reference C-DU configuration. At block 1110, the DU transmits a DU-to-CU message, including the at least one C-DU configuration, to the CU (e.g., events 374, 390, or 490). Otherwise, if the DU determines that the CU-to-DU message includes a reference C-DU configuration at block 1104, the flow proceeds to block 1108.

In some implementations, the CU-to-DU message and DU-to-CU message are a UE Context Setup Request message and UE Context Setup Response message, respectively.

FIG. 11B illustrates an example method 1100B similar to the method 1100A, except that the method 1100B includes a block 1105. If the DU determines that the CU-to-DU message does not include a reference C-DU configuration at block 1104, the flow proceeds to block 1105. At block 1105, the DU determines whether the DU has a reference C-DU configuration for the UE. If the DU determines that the DU has a reference C-DU configuration for the UE at block 1105, the flow proceeds to block 1108. Otherwise, if the DU determines that the DU does not have a reference C-DU configuration for the UE at block 1105, the flow proceeds to block 1106.

In some implementations, the DU has (e.g., stores) a reference C-DU configuration at block 1105 because the DU receives another CU-to-DU message, including the reference C-DU configuration, from the CU before receiving the CU-to-DU message at block 1102. In other implementations, the DU has a reference C-DU configuration at block 1105 because the DU generates the reference C-DU configuration before receiving the CU-to-DU message at block 1102.

In some implementations, the DU of the methods 1100A and 1100B is the DU of the method 600A, 600B, or 1000 and, as such, the descriptions related to the DU in FIGS. 6A, 6B, or 10 can apply to the DU of the methods 1100A and 1100B. Likewise, the descriptions for FIGS. 11A and 11B can apply to FIGS. 6A, 6B, or 10.

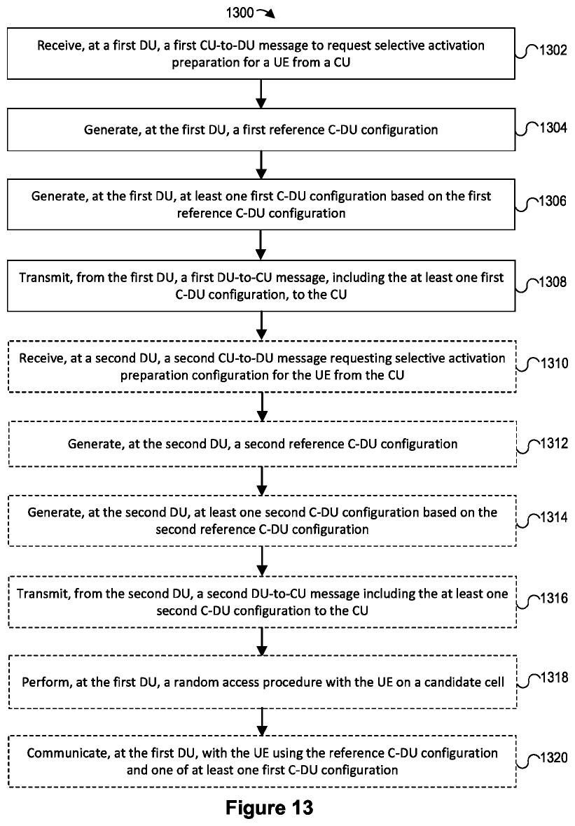

FIG. 12 illustrates an example method 1200, which a CU of a base station (e.g., the CU 172 of the base station 106A or 106B) can implement, for communicating with a UE (e.g., the UE 102).

The method 1200 begins at block 1202, where the CU performs at least one first selective activation preparation procedure with a first DU to obtain, from the first DU, a first reference C-DU configuration and at least one first C-DU configuration for a UE (e.g., events 390 or 490). At block 1204, the CU transmits the first reference C-DU configuration and at least one first C-DU configuration to the UE (e.g., events 306-308, 406-408 or 407-409). In some implementations, the at least one first C-DU configuration is a non-reference C-DU configuration(s).

At block 1206, the CU performs at least one second selective activation preparation procedure with a second DU to obtain, from the second DU, a second reference C-DU configuration and at least one second C-DU configuration for the UE (e.g., events 390 or 490).

In some implementations, the at least one second C-DU configuration is a non-reference C-DU configuration(s). At block 1208, the CU transmits the second reference C-DU configuration and at least one second C-DU configuration to the UE via the first DU (e.g., events 407-409).

Alternatively, the CU transmits the second reference C-DU configuration and at least one second C-DU configuration to the UE via a RAN node (e.g., events 306-308 or 406-408). In some implementations, the RAN node is another DU or base station. Blocks 1206 and 1208 are optional.

In some implementations, the at least one first selective activation preparation procedure occurs in parallel with the at least one second selective activation preparation procedure. In other implementations, the at least one first selective activation preparation procedure occurs before the at least one second selective activation preparation procedure. In yet other implementations, the at least one first selective activation preparation procedure occurs after the at least one second selective activation preparation procedure.

In the method 1200, the first DU and second DU manage the first reference C-DU configuration and second reference C-DU configuration, respectively. An advantage of the method 1200 is that the selective activation preparation for cell(s) of non-serving DUs has no dependency with the selective activation preparation for cell(s) of a serving DU. Thus, the CU can prepare cell(s) of a non-serving DU without performing a selective activation preparation with the serving DU, simplifying the selective activation preparation with non-serving DUs.

In some implementations, the at least one first selective activation preparation procedure includes a UE Context Setup procedure and optionally zero, one, or more UE Context Modification procedures. In some implementations, the at least one second selective activation preparation procedure includes one or more UE Context Modification procedures.

In some implementations, the CU generates a first container (e.g., a field/IE) including the first reference C-DU configuration, generates a first message including the first container, and transmits the first message to the UE via the first DU. In some implementations, the CU includes the at least one first C-DU configuration in the first container. In other implementations, the CU generates a second container (e.g., a field/IE) including the at least one first C-DU configuration. In some implementations, the CU includes the second container in the first message. In further implementations, the CU generates a second message, including the second container, and transmits the second message to the UE via the first DU.

In some implementations, the CU generates a third container (e.g., a field/IE) including the second reference C-DU configuration, generates a third message including the third container, and transmits the third message to the UE via the first DU. In some implementations, the CU includes the at least one second C-DU configuration in the third container. In other implementations, the CU generates a fourth container (e.g., a field/IE) including the at least one second C-DU configuration. In some implementations, the CU includes the fourth container in the third message. In further implementations, the CU generates a fourth message, including the fourth container, and transmits the fourth message to the UE via the first DU.

In some implementations, the first container and the third container are different fields/IEs and, thus, the UE does not replace the first reference C-DU configuration with the second reference C-DU configuration. In other implementations, the first container and third container follow the same format (i.e., a field/IE), and the first container and third container include a first ID and a second ID, respectively. The first ID and the second ID follow the same format (i.e., a field/IE), and the CU sets the first ID and second ID to a first value and a second value, respectively. Because the first ID and the second ID have different values, the UE does not replace the first reference C-DU configuration with the second reference C-DU configuration or vice versa. Because the first ID and the second ID have different values, the UE does not replace the at least one first C-DU configuration with the at least one second C-DU configuration or vice versa, if the first container and the third container include the at least one first C-DU configuration and the at least one second C-DU configuration, respectively. In some implementations, the first ID and the second ID identify the first reference C-DU configuration and the second reference C-DU configuration, respectively. In other implementations, the first ID and the second ID identify the second DU and the first DU, respectively. In yet other implementations, the first ID and the second ID identify a cell group of the second DU and a cell group of the first DU, respectively. In yet other implementations, the first ID and the second ID identify the first container and third container, respectively.

In some implementations, the second container and the fourth container are different fields/IEs and, thus, the UE does not replace the at least one first reference C-DU configuration with the at least one second C-DU configuration. In other implementations, the second container and the fourth container follow the same format (i.e., a field/IE), and the second container and fourth container include a third ID and a fourth ID, respectively. The third ID and the fourth ID follow the same format (i.e., a field/IE), and the CU sets the third ID and the fourth ID to a third value and a fourth value, respectively. Because the third ID and fourth ID have different values, the UE does not replace the at least one first C-DU configuration with the at least one second C-DU configuration. In some implementations, the third ID and the fourth ID identify the at least one first C-DU configuration and the at least one second C-DU configuration, respectively. In other implementations, the third ID and the fourth ID identify the second DU and the first DU, respectively. In yet other implementations, the third ID and the fourth ID identify a cell group of the second DU and a cell group of the first DU, respectively. In yet other implementations, the third ID and the fourth ID identify the second container and the fourth container, respectively.

In some alternative implementations, the second DU generates the first and/or second containers instead of the CU. In such cases, the CU receives the first and/or second containers from the second DU in the at least one first selective activation preparation procedure. In some alternative implementations, the first DU generates the third and/or fourth containers instead of the CU. In such cases, the CU receives the third and/or fourth containers from the first DU in the at least one second selective activation preparation procedure.

FIG. 13 illustrates an example method 1300, which one or more DUs (e.g., the S-DU 174A and/or T-DU 174B of the base station 106A or 106B) can implement, for communicating with a UE (e.g., the UE 102) and a CU (e.g., the CU 172 of the base station 106A or 106B).

The method 1300 begins at block 1302, where a first DU receives a first CU-to-DU message to request selective activation preparation for a UE from a CU (e.g., events 390 or 490). At block 1304, the first DU generates a first reference C-DU configuration (e.g., events 390 or 490). At block 1306, the first DU generates at least one first C-DU configuration based on the first reference C-DU configuration (e.g., events 390 or 490). At block 1308, the first DU transmits a first DU-to-CU message, including the at least one first C-DU configuration, to the CU (e.g., events 390 or 490).

At block 1310, a second DU receives a second CU-to-DU message requesting selective activation preparation configuration for the UE from the CU (e.g., events 390 or 490). At block 1312, the second DU generates a second reference C-DU configuration (e.g., events 390 or 490). At block 1314, the second DU generates at least one second C-DU configuration based on the second reference C-DU configuration (e.g., events 390 or 490). At block 1316, the second DU transmits a second DU-to-CU message, including the at least one second C-DU configuration, to the CU (e.g., events 390 or 490). At block 1318, the first DU performs a random access procedure with the UE (e.g., events 318 or 418). At block 1320, the first DU communicates with the UE using the reference C-DU configuration and one of at least one first C-DU configuration (e.g., events 336 or 436). Blocks 1310, 1312, 1314, 1316, 1318, and/or 1320 are optional.

In some implementations, blocks 1310, 1312, 1314, and 1316 occur in parallel with blocks 1302, 1304, 1306, and 1308. In other implementations, blocks 1310, 1312, 1314, and 1316 occur after blocks 1302, 1304, 1306, and 1308. In yet other implementations, blocks 1310, 1312, 1314, and 1316 occur before blocks 1302, 1304, 1306, and 1308.

In some implementations, the first DU, the second DU, and the CU form a disaggregated base station.

In some implementations, the first CU-to-DU message and first DU-to-CU message are a UE Context Setup Request message and UE Context Setup Response message, respectively. In other implementations, the first CU-to-DU message and first DU-to-CU message are a UE Context Modification Request message and UE Context Modification Response message, respectively. In some implementations, the second CU-to-DU message and second DU-to-CU message are a UE Context Modification Request message and UE Context Modification Response message, respectively. In other implementations, the second CU-to-DU message and second DU-to-CU message are a UE Context Setup Request message and UE Context Setup Response message, respectively.

In some implementations, the first DU receives a third CU-to-DU message requesting selective activation preparation configuration for the UE from the CU (e.g., events 390 or 490). The first DU generates at least one third C-DU configuration based on the first reference C-DU configuration (e.g., events 390 or 490). The first DU transmits a third DU-to-CU message, including the at least one third C-DU configuration, to the CU (e.g., events 390 or 490). In some implementations, the third CU-to-DU message and third DU-to-CU message are a UE Context Modification Request message and UE Context Modification Response message, respectively.

The following description may be applied to the description above.

Generally speaking, description for one of the above figures can apply to another of the above figures. Examples, implementations and methods described above can be combined, if there is no conflict. An event or block described above can be optional or omitted. For example, an event or block with dashed lines in the figures can be optional. In some implementations, “message” is used and can be replaced by “information element (IE)”. In some implementations, “IE” is used and can be replaced by “field”. In some implementations, “configuration” can be replaced by “configurations” or the configuration parameters. In some implementations, the “CPAC”, “CPA” and/or “CPC” are interchangeable. In some implementations, “reference C-SN configuration” can be replaced by “reference C-SN configuration” or “reference configuration”. In some implementations, “triggering condition” and “triggering condition configuration” can be replaced by “execution condition” and “execution condition configuration”, respectively.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IOT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method implemented in a centralized unit (CU) of a distributed secondary node (SN) providing dual connectivity to a user equipment (UE) with a master node (MN) in accordance with an initial configuration, the method comprising:
initiating an activation preparation procedure for conditional primary-secondary cell (PSCell) addition or change (CPAC) for the UE;
receiving, from a distributed unit (DU) of the distributed SN and responsive to the initiating, a reference candidate DU (C-DU) configuration for CPAC; and
transmitting a conditional SN (C-SN) configuration based on the reference C-DU configuration for the UE.

2. The method of claim 1, further comprising:
receiving, from the DU, an indication of whether the reference C-DU configuration is a complete configuration.

3. The method of claim 1, wherein:
the receiving the reference C-DU configuration includes receiving the reference C-DU configuration in a UE context setup response message.

4. The method of claim 1, wherein:
the receiving the reference C-DU configuration includes receiving the reference C-DU configuration in a UE context modification response message.

5. The method of claim 1, wherein:
the initiating includes transmitting, from the CU to the DU, a configuration request for the reference C-DU configuration; and
the receiving the reference C-DU configuration is responsive to the transmitting the configuration request.

6. The method of claim 1, wherein:
the receiving the reference C-DU configuration and the transmitting the C-SN configuration based on the reference C-DU configuration occur in a first instance;
the reference C-DU configuration is a first reference C-DU configuration;
the C-SN configuration is a first C-SN configuration; and
the method further comprises, in a second instance:
transmitting, to the DU, a second reference C-DU configuration;
receiving, from the DU, a non-reference C-DU configuration; and
transmitting, a second C-SN configuration based on the non-reference C-DU configuration.

7. The method of claim 1, wherein:
the C-SN configuration is a reference C-SN configuration.

8. A method implemented in a distributed secondary node (SN) providing dual connectivity to a user equipment (UE) with a master node (MN) in accordance with an initial configuration, the method comprising:
receiving, at a first distributed unit (DU) of the distributed SN, an indication to perform an activation preparation procedure for conditional primary-secondary cell (PSCell) addition or change (CPAC) for the UE;
transmitting, from the first DU to a centralized unit (CU) of the distributed SN and responsive to the receiving the indication, a reference candidate DU (C-DU) configuration for CPAC; and
receiving, at a second DU of the distributed SN from the CU, a conditional SN (C-SN) configuration based on the reference C-DU configuration for the UE.

9. The method of claim 8, further comprising:
transmitting, from the first DU to the CU, an indication of whether the reference C-DU configuration is a complete configuration.

10. The method of claim 8, wherein:
the transmitting the reference C-DU configuration includes transmitting the reference C-DU configuration in a UE context setup response message.

11. The method of claim 8, wherein:
the transmitting the reference C-DU configuration includes transmitting the reference C-DU configuration in a UE context modification response message.

12. The method of claim 8, wherein:
the receiving the indication includes receiving, at the first DU and from the CU, a configuration request for the reference C-DU configuration; and
the transmitting the reference C-DU configuration is responsive to the receiving the configuration request.

13. The method of claim 8. wherein:
the transmitting the reference C-DU configuration and the receiving the C-SN configuration based on the reference C-DU configuration occur in a first instance;
the reference C-DU configuration is a first reference C-DU configuration;
the C-SN configuration is a first C-SN configuration; and
the method further comprises, in a second instance:
receiving, at the first DU and from the CU, a second reference C-DU configuration;
transmitting, from the first DU to the CU, a non-reference C-DU configuration; and
receiving, at the second DU and from the CU, a second C-SN configuration based on the non-reference C-DU configuration.

14. The method of claim 8. wherein:
the C-SN configuration is a reference C-SN configuration.

15. An apparatus, operating as a centralized unit (CU) of a distributed radio access network (RAN) node functioning as a secondary node (SN) providing dual connectivity to a user equipment (UE) with a master node (MN) in accordance with an initial configuration, comprising processing hardware configured to:
initiate, at the CU, an activation preparation procedure for conditional primary-secondary cell (PSCell) addition or change (CPAC) for the UE;
receive, at the CU from a distributed unit (DU) of the distributed SN and responsive to initiating the activation preparation procedure, a reference candidate DU (C-DU) configuration for CPAC; and
transmit, from the CU, a conditional SN (C-SN) configuration based on the reference C-DU configuration for the UE.

16. The apparatus of claim 15, wherein the processing hardware is further configured to:
receive, from the DU, an indication of whether the reference C-DU configuration is a complete configuration.

17. The apparatus of claim 15, wherein the processing hardware configured to receive the reference C-DU configuration is further configured to:
receive the reference C-DU configuration in a UE context setup response message.

18. The apparatus of claim 15, wherein the processing hardware configured to receive the reference C-DU configuration is further configured to:
receive the reference C-DU configuration in a UE context modification response message.

19. The apparatus of claim 15, wherein:
the processing hardware configured to initiate the activation preparation procedure is further configured to transmit, to the DU, a configuration request for the reference C-DU configuration; and
the processing hardware configured to receive the reference C-DU configuration is further configured to receive the reference C-DU configuration responsive to transmitting the configuration request.

20. The apparatus of claim 15, wherein:
the C-SN configuration is a reference C-SN configuration.
